(19) United States
(12) Patent Application Publication
(10) Pub. No.: US 2013/0328318 A1
(43) Pub. Date: Dec. 12, 2013

(54) MOVABLE OBJECT-MOUNTED WIND POWER GENERATING APPARTUS

(71) Applicant: Hideaki OZAWA, Tokyo (JP)

(72) Inventor: Hideaki OZAWA, Tokyo (JP)

(21) Appl. No.: 13/913,174

(22) Filed: Jun. 7, 2013

(30) Foreign Application Priority Data
Jun. 8, 2012 (JP) 2012-130626
Mar. 19, 2013 (JP) 2013-056286

(51) Int. Cl. F03D 9/00

(52) U.S. Cl. CPC F03D 9/002
USPC 290/55

(57) ABSTRACT

A movable object-mounted wind power generating apparatus includes an air introducing member being attached to an inside or an outside of an movable object and having, at one end thereof, an air inlet which introduces air to be received by the movable object and, at the other end thereof, an air outlet which discharges the air introduced from the air inlet, a generator driving mechanism which is rotatably disposed inside the air introducing member and is connected with a power generator and which is driven by the air introduced inside the air introducing member from the air inlet. The drain mechanism has a drain chamber which is in communication with the air outlet of the air introducing member and to which the air discharged from the air outlet is introduced, and the drain chamber has a cross-sectional area larger than an opening area of the air outlet.

### CROSS-REFERENCE TO RELATED APPLICATIONS

The present application is based on and claims priority from each of Japanese Patent Application Number 2012-130626, filed on Jun. 8, 2012 and Japanese Patent Application Number 2013-56286, filed on Mar. 19, 2013, the disclosure of which is hereby incorporated by reference herein in its entirety.

### BACKGROUND OF THE INVENTION

1. Field of the Invention

The present invention mainly relates to a movable object-mounted wind power generating apparatus which is mounted on a movable object, such as an automobile (especially, an electric vehicle), a train, a ship, an airplane, or a helicopter and is configured to generate electric power to be supplied to an electric motor for driving the movable object or electric devices such as other meters with wind force to be generated while the movable object is running.

2. Description of the Related Art

Recently, there are an increasing number of automobiles, especially, vehicles such as electric vehicles, which run by using an electric motor as a driving source. In the case of the vehicle driven by the electric motor, a capacitance of a battery to supply the electric motor with electric power has to be secured. Accordingly, an automobile in which a wind power generating apparatus to generate electricity to be charged in a battery is mounted has been proposed. For example, when a vehicle such as a passenger vehicle or an autobus runs, running wind corresponding to the speed of the vehicle is applied to the front side of the vehicle and power is generated with the wind force generated while the vehicle runs. As one example of this, as shown in FIG. 24A, a configuration in which two wind power generating apparatuses 102, 102 are disposed on a roof of an automobile 101 is proposed (see, Japanese Patent Application Publication No. Hei 10-215502 (paragraphs 0016, 0017, and 0019, and FIGS. 1, 2, and 7A)). Each of the wind power generating apparatuses 102, 102 has a longitudinal direction parallel with the front-rear direction of the automobile 101. Furthermore, the wind power generating apparatus 102 is disposed with a rear end portion being lifted at an angle of approximately 5° than a front end portion for preventing the uplift of the vehicle. Also, a controller for controlling the battery 113 and the wind power generating apparatus 102 is built in the automobile 101, and the battery 113 and the controller 104 are electrically connected with the wind power generating apparatus 102.

The battery 113 supplies a motor with electric power to supply electric systems of the automobile 101 with the electric power. As shown in FIGS. 24A and 24B, the wind power generating apparatus 102 includes a circular duct 102a. In a substantially center portion of the duct 102a, a supporting portion 102b extends in the vertical direction to the center axial line, and the body 102c is fixed in the supporting portion 102b.

On the front end portion side of the body 102c of the power generator, a propeller 102d which rotates with wind is provided. The rotation of the propeller 102d generates electric power. Also, on the front end portion of the circular duct 102a, an air inlet 110 is formed to be widened at an angle of approximately 5° toward the outside. To prevent the uplift of the duct 102a, the front shape of the air inlet 110 has horizontal portions which are formed by cutting out upper and lower are portions as shown in FIG. 24C. When the automobile 101 runs, wind is taken to the air inlet 110. At this time, the wind flows so as to pass through the duct 102a as shown in FIG. 24A. With the wind, the propeller 102d rotates to generate power. Then, the wind power generating apparatus 102 sends the generated power to the battery 113. The battery 113 stores the power and supplies the motor with the power when the motor operates.

### SUMMARY OF THE INVENTION

However, as shown in FIG. 24A and FIG. 24B, in the wind power generating apparatus 102 as described above, wind is directly taken from the air inlet 110 of the duct 102a with the cylindrical shape when the automobile 101 runs, but foreign substances or particles such as dust are also taken into the air inlet 110 together with the wind. If the foreign substances such as dust are hard, they directly collide with the propeller 102d together with the wind, which may damage the propeller 102d. Also, if the automobile 101 is driven under bad weather such as rain, rainwater and the like are taken into the air inlet 110 of the duct 102a together with the wind. In this case, the duct 102a may rust depending on a material thereof, or an axis to rotate the propeller 102d may be deteriorated with the water such as rainwater adhered to the axis. Furthermore, in the wind power generating apparatus 1, the body 102c of the power generator in which the propeller 102d is provided has to be fixed so as to go along the direction of the center axis of the duct 102a. However, as shown in FIG. 24B and FIG. 24C, if it has to be fixed by a plate-like member of a supporting portion 102b, the operation becomes difficult.

To fix the body 102c of the power generator so as to go along the direction of the center axis of the duct 102a, an adequate portion of the body 102c of the power generator is held and fixed by the plate-like member of the supporting portion 102b. However, if the body is fixed off the adequate position, the body 102e of the power generator may be inclined to the direction of the center axis of the duct 102c when wind enters the duct 102c. Also, the body 102 of the power generator is set in the duct 102a and the body 102c of the power generator is supported only by the plate-like member of the supporting portion 102. Accordingly, this configuration is difficult to secure the security of the body 102c of the power generator. Therefore, there is a possibility that the body 102c of the power generator is displaced from the supporting portion 102b when any external force is applied to the automobile 101 and the propeller 102d comes in touch with the duct 102a, which results in causing the propeller 102d to be difficult to rotate. Also, it is preferable that when the power generator is disposed inside the vehicle, wind, rainwater, and the like which are taken into the power generator disposed in the vehicle for power generation be buffered and be quickly and smoothly discharged to the outside of the vehicle. Furthermore, it is also preferable that a proper wind power generating apparatus for charging a battery is mounted not only in electric vehicles, but also in, for example, gasoline engine vehicles.

The present invention has been made in consideration with the above-described circumstances. For example, an object of the present invention is to provide a movable object-mounted wind power generating apparatus in which when a movable object runs, any battery disposed in the movable object can be effectively charged, and even when air containing water such as rainwater is directly received by the vehicle while the automobile or the like runs, foreign substances such as dust are prevented from entering the vehicle, and even when the air containing water such as rainwater enters inside the vehicle under bad weather, the air can be quickly and smoothly discharged to the outside of the vehicle and also the air introduced in a rushed manner to the vehicle can be buffered and discharged to the outside of the vehicle. Thus, this can be securely attached to the vehicle such as the automobile.

To achieve the above object, a movable object-mounted wind power generating apparatus according to an embodiment includes: an air introducing member being attached to an inside of a movable object and having, at one end thereof, an air inlet which introduces air to be received by the movable object and, at the other end thereof, an air outlet which discharges the air introduced from the air inlet; a generator driving mechanism which is disposed to be rotatable by the air introduced inside the air introducing member and is connected with a power generator; and a drain mechanism which is connected with the air outlet and discharges the air inside the air introducing member to an outside of the movable object. The drain mechanism has a drain chamber which is in communication with the air outlet of the air introducing member to receive the air inside the air introducing member from the air outlet. The drain chamber has a cross-sectional area (or volume) larger than an opening area of the air outlet. Furthermore, the drain chamber has an elliptic rotating body in one embodiment and has an inner wall, which faces the air outlet, bulged toward the outside. Furthermore, a filter is provided in the air inlet to prevent dirt, dust, and the like from entering the hollow body.

The movable object-mounted wind power generating apparatus according to one embodiment of the present invention can effectively generate power by rotating the generator driving mechanism with the air introduced from the air inlet to the air introducing member when the air passes the generator driving mechanism. In addition, even when the introduced air contains water such as rainwater, the air containing rainwater and the like reaches the drain chamber of the drain mechanism and is finally discharged to the outside of the vehicle body of the movable object, for example, the electric vehicle. As a result, the movable object generates power when running and the air containing water such as rainwater does not enter the vehicle body other than the passing way. Furthermore, since the drain chamber in communication with the air outlet of the air introducing member has a cross-sectional area (or volume) larger than the air outlet, the air expands when the air enters the drain chamber form the air outlet and thus the speed and pressure are weakened. Accordingly, the air taken from the air inlet for power generation decreases speed and loses stream in the drain chamber, and then is quickly discharged to the outside of the vehicle body from the drain chamber. In other words, the air having been taken in a rushed manner from the air outlet is buffered in the drain chamber. Also, since the inner surface of the drain chamber, which faces the air outlet, is bulged toward the outside, the air blown from the air outlet is further weakened and gathered by a recessed curved surface when the air flown from the air outlet collides with the inner wall. Then, the gathered air is smoothly discharged to the outside of the vehicle body from the drain chamber. In this manner, the momentum of the air and the like is weakened and gathered, and thus air containing water, dust, and the like can be particularly gathered in a predetermined one place before being discharged to the outside of the movable object.

In addition, a filter is attached to the air inlet to prevent foreign substances such as dust from entering the vehicle body when the air is taken while the movable object (for example, the electric vehicle) is running.

### BRIEF DESCRIPTION OF THE DRAWINGS

FIG. 1 is an entire schematic configuration diagram showing an embodiment in which a movable object-mounted wind power generating apparatus is applied to an automobile which is an example of a movable object;

FIGS. 2A and 2B are views showing each port of the movable object-mounted wind power generating apparatus which is mounted in the automobile, in which FIG. 2A is an illustration showing a cross-section taken along the H-H line shown in FIG. 1 and FIG. 2B is a front view in which an air inlet of the movable object-mounted wind power generating apparatus shown in FIG. 1 is seen from the front side;

FIG. 3A is an exploded perspective drawing when a filter is fixed to the air inlet and FIG. 3B is a partial cross-section showing a state where the filter is fixed to the air inlet;

FIGS. 4A and 4B are views showing an inside of an air introducing member, in which FIG. 4A is a cross-section taken along the Y-Y line of FIG. 1, which shows a concept of support of the shaft portion and a fan blade portion inside the air introducing member and FIG. 4B is a conceptual illustration of a state of the shaft portion inside the air introducing member shown form the cross-sectional direction taken along the T-T line of FIG. 4A;

FIG. 5 is a cross-sectional view which is taken along the Y-Y line of FIG. 1 but is different from FIGS. 4A and 4B showing the concept between the support of the shaft portion and the fan blade portion inside the air introducing member;

FIGS. 6A and 6B are views showing a drain chamber of the movable object-mounted wind power generating apparatus according to the present invention, in which FIG. 6A is a cross-section taken along the Z-Z line of FIG. 1 and FIG. 6B is a cross-section taken along the S-S line of FIG. 6A;

FIGS. 7A and 7B are views showing another drain chamber of the movable object-mounted wind power generating apparatus according to the present invention, in which FIG. 7A is a cross-section taken along the Z-Z line of FIG. 1 and FIG. 7B is a cross-section taken along the S-S line of FIG. 7A;

FIGS. 8A to 8C are views showing how a water splattering prevention plate is attached at an outlet of the drain chamber shown in FIGS. 7A and 7B, in which FIG. 8A is an illustration showing a position where the water splattering prevention plate to the outlet of the drain chamber is attached, FIG. 8B is an extended view showing a portion of the water splattering prevention plate to the outlet shown in FIG. 8A, and FIG. 8C is an illustration showing that water such as rainwater moves in the drain chamber when wind is blown by a blower fan;

FIGS. 9A and 9B are views showing the drain chamber of a movable object-mounted wind power generating apparatus according to another embodiment of the invention, in which FIG. 9A is an illustrational cross-section taken along the Z-Z line of FIG. 1 and FIG. 9B is an illustrational cross-section taken along the S-S line of FIG. 9A;

FIGS. 10A and 10B are views showing a drain chamber of a movable object-mounted wind power generating apparatus according to another embodiment, in which FIG. 10A is an illustrational cross-section taken along the Z-Z line of FIG. 1 and FIG. 10B is a schematic illustrational cross-section taken along the S-S line of FIG. 10A;

FIGS. 11A and 11B are views showing an example in which the movable object-mounted wind power generating apparatus according to the present invention is mounted in the front center of an automobile, in which FIG. 11A is an illustration which is seen from above the automobile and shows a position where the movable object-mounted wind power generating apparatus according to the invention is mounted and FIG. 11B is an illustration which is seen from the side of the automobile and shows a position where the movable object-mounted wind power generating apparatus according to the invention is mounted;

FIGS. 12A and 12B are views showing an example in which two movable object-mounted wind power generating apparatuses according to the invention are mounted side by side on the front side of the automobile and FIG. 12B is an illustration which is seen from the side of the automobile and shows a position where the movable object-mounted wind power generating apparatus according to the invention is mounted;

FIGS. 13A and 13B are views showing an example in which movable object-mounted wind power generating apparatuses according to the invention are mounted rearwardly on both sides of an automobile, in which FIG. 13A is an illustration which is seen from above the automobile and shows a position where the movable object-mounted wind power generating apparatuses according to the invention are mounted and FIG. 13B is an illustration which is seen from the side of the automobile and shows a position where the movable object-mounted wind power generating apparatuses according to the invention are mounted;

FIGS. 14A and 14B are views showing an example in which the movable object-mounted wind power generating apparatus according to the invention is mounted in the front center of the automobile and the air inlet and the air introducing member are overlapped with each other, in which FIG. 14A is an illustration which is seen from above the automobile and shows a position where the movable object-mounted wind power generating apparatus according to the invention is mounted and FIG. 14B is an illustration which is seen from the side of the automobile and shows a position where the movable object-mounted wind power generating apparatus according to the invention is mounted;

FIGS. 15A to 15C are views showing an example in which a drain box is directly attached to the drain chamber of the movable object-mounted wind power generating apparatus according to the invention shown in FIGS. 9A and 9B, in which FIG. 15A is an illustrational cross-section mainly showing an inside of the drain chamber of the movable object-mounted wind power generating apparatus similar to the cross-section shown in FIG. 9A and FIG. 15B is an illustrational cross-sectional taken along the U-U line of FIG. 15A, and FIG. 15C is an illustrational cross-section shown from the direction along the T-T line of FIG. 15B;

FIGS. 16A to 16C are views showing a modified example of the movable object-mounted wind power generating apparatus shown in FIGS. 15A to 15C, in which FIG. 16A is an illustrational cross-section mainly showing an inside of the drain chamber of the movable object-mounted wind power generating apparatus shown in FIG. 15A and FIG. 16B is an illustrational cross-section taken along the U-U line of FIG. 16A, and FIG. 16C is an illustrational cross-section along the T-T line of FIG. 16B;

FIG. 17 is a schematic side view of a second embodiment of the present invention, which shows a state where a movable object-mounted wind power generating apparatus according to the invention is applied to a train.

FIG. 18 is a schematic front view of a train according to the second embodiment;

FIG. 19 is a schematic plan view of the train, which shows a disposed state of the movable object-mounted wind power generating apparatus in the second embodiment;

FIG. 20 is a schematic front view of a train, which specifically shows a disposed state of the movable object-mounted wind power generating apparatus in the second embodiment;

FIGS. 21A to 21C show how the movable object-mounted wind power generating apparatus is attached to the train in the second embodiment, in which FIG. 21A is a schematic cross-section, FIG. 21B is a schematic cross-section, and FIG. 21C is a schematic side view showing the attached configuration of a protection case;

FIG. 22A is a schematic illustration showing a state where a discharge guide plate is provided in the automobile in the first embodiment and FIG. 22B is a schematic cross-sectional view showing an opening and a discharge guide plate which are provided for discharging air to the protection case of the wind power generating apparatus mounted on the train in the second embodiment;

FIGS. 23A and 23B are schematic cross-sectional views showing an embodiment when the movable object-mounted wind power generating apparatus according to the invention is applied to a gasoline engine vehicle or HEV or diesel engine vehicle; and

FIG. 24A is a schematic perspective view of an automobile to which a conventional wind power generating apparatus is applied and FIG. 24B is a horizontal cross-sectional view of the conventional wind power generating apparatus, and FIG. 24C is a front view of the conventional wind power generating apparatus.

### DESCRIPTION OF THE PREFERRED EMBODIMENTS

Embodiments for carrying out the invention are described hereinafter in detail with reference to the accompanying drawings.

Firstly, a movable object-mounted wind power generating apparatus is configured so as to be mounted on a movable object, take wind which is generated while the movable object is running, and then drive a power generator with the taken wind to generate electric power which is stored in a battery. Here, the movable object includes all movable objects such as automobile (including hybrid and electric vehicles), trains, ships, airplanes, and the like. In the present description, an example is given of a case where a wind power generating apparatus 1 according to the present invention is applied to an electric vehicle and a train. However, it should be noted that the present invention is not limited to this example.

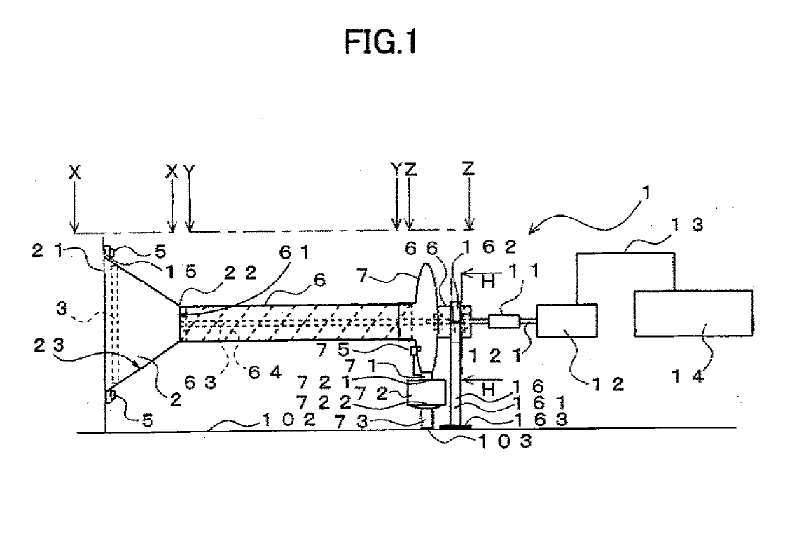

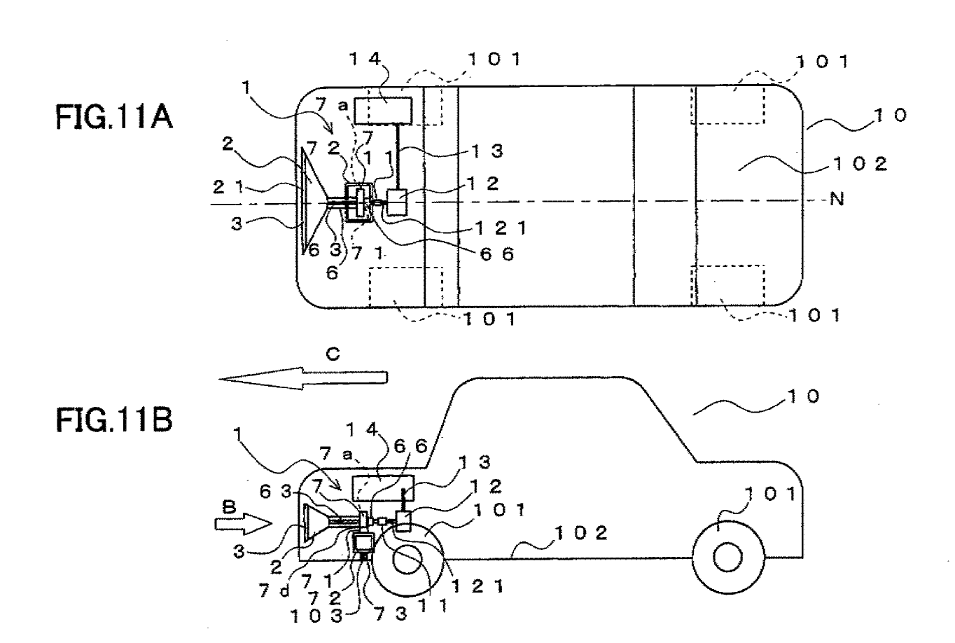

FIG. 1 to FIGS. 13A and 13B show a first embodiment of a movable object-mounted wind power generating apparatus according to the present invention. In the first embodiment, the wind power generating apparatus 1 is applied to an automobile 10 as an example of the movable object (see FIG. 11A and FIG. 11B). As shown in FIG. 1, the wind power generating apparatus 1 according the first embodiment is sequentially connected with an air inlet 2, an air introducing member 6, a drain chamber 7, and a supporting portion 66, a joint 11, a power generator 12, and a battery in this order. The air introducing member 6 includes a cylindrical member. As described later, the air taken through the air inlet 2 reaches the drain chamber 7 after the air introducing member 6.

This wind power generating apparatus 1 is fixed in any position of a vehicle body of an automobile by a fixing mechanism. The fixing mechanism includes a frame portion 15 to fix the air inlet 2 to the vehicle body and a supporting mechanism 16 which fixes the supporting portion 66 provided on the side opposite to the air inlet 2 to the vehicle body. The supporting mechanism 16 includes, for example, a columnar portion 161 and a holding portion 160 attached to an upper end of the columnar portion 161. At a lower end of the columnar portion 161, a fixing plate 163 is fixed. The fixing plate 163 is, as shown in FIG. 1, fixed to, for example, a bottom surface of a vehicle engine room (a floor surface 102). The columnar portion 161 and the fixing plate 163 are attached by connecting the columnar portion 161 and the fixing plate 163 with an unillustrated bolt being fastened from the fixing plate 161 side. The fixing plate 163 is attached to the floor surface 102, for example, by connecting the fixing plate 163 to the floor surface 102 with unillustrated multiple bolts being fastened from the fixing plate 163 side to the floor surface 102 side, so that the supporting mechanism 16 is attached to the floor surface 102. In the above description, bolts are used for the attachment, but the attachment may be made by welding.

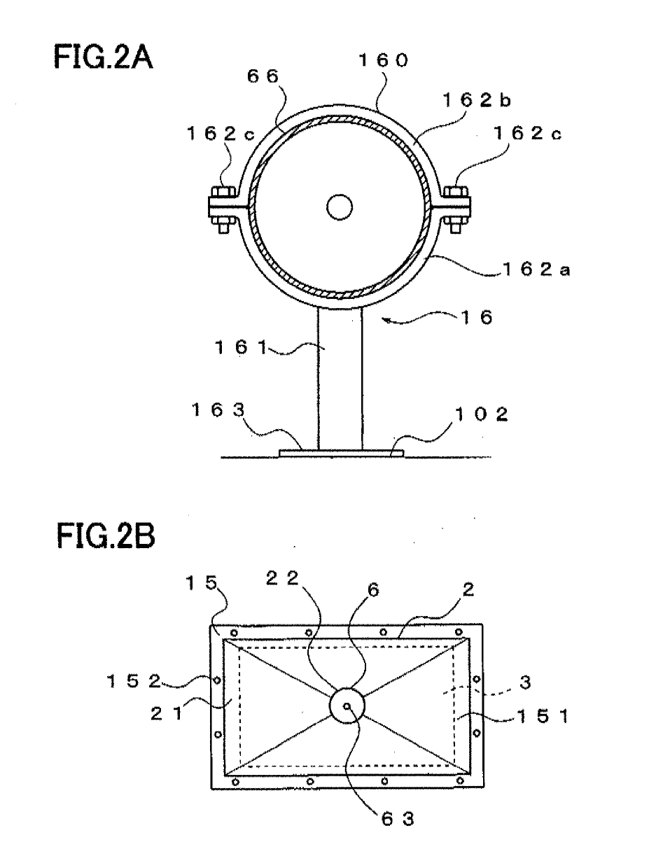

The holding portion 160 includes, for example, two grip members 162a, 162b disposed so as to surround the supporting portion 66 and a screw 162c to fasten these grip members 162a, 162b. When the supporting portion 66 has a circular outer periphery, each of these grip members 162a, 162b has a semi-circular inner periphery which is formed by dividing the inner periphery of a circle corresponding to the circular outer periphery of the supporting portion 66 into substantially half. As shown in FIGS. 2A and 2B, these grip members 162a, 162b are disposed so as to hold the supporting portion 66 therebetween. The supporting portion 66 can be fixed by fastening the grip members 162a, 162b with the screw 162c.

Also, when fixing the air inlet 2 provided on one end side of the wind power generating apparatus 1, as shown in FIG. 1, the frame portion 15 is set in the air inlet 2. The wind power generating apparatus 1 is attached to the side on the bottom surface of the vehicle engine room (the floor surface 102) so that air can be taken from one end portion 21 of the air inlet 2 in which the frame portion 15 is set when the automobile is running. As shown in FIG. 28, the frame portion 15 has a rectangular shape on the one end portion 21 side of the air inlet 2 in this embodiment. Thus, the shape of a center hole 151 formed in the center of the frame portion 15 matches with the shape on the one end portion 21 side of the air inlet 2. The one end portion 21 side of the air inlet 2 is fitted in the center hole 151 of the frame portion 15. In this embodiment, a portion where the frame portion 15 comes in contact with the one end portion 21 side of the air inlet 2 is, for example, welded, and thus the frame portion 15 and the one end portion 21 side of the air inlet 2 are connected with each other. However, the way of their connection is not limited to the welding, but, for example, the frame portion 15 and the one end portion 21 side of the air inlet 2 may be connected by applying an adhesive to a portion where the frame portion 15 and the one end portion 21 side come in contact with each other.

As described above, the frame portion 15 attached to the one end portion 21 side of the air inlet 2 is fixed inside a vehicle so that air can be taken into the wind power generating apparatus 1 from the outside of the vehicle. For this reason, as shown in FIG. 2B, multiple hole portions 152 are formed along the outer circumference of the frame portion 15, and fixing members 5 such as bolts are set in these hole portions 152, so that the one end portion 21 side of the air inlet 2 is fixed in the vehicle (see, FIG. 1). In this embodiment, the air inlet 2, the frame portion 15, and the like are metal members, but they are not limited to metal and may use a resin member. Note that when the air inlet 2 and the like are made of a metal, a waterproof coating material may be applied to any portion of these members to prevent corrosion due to rainwater. The air inlet 2 has a hollow portion inside, and, as shown in FIG. 1, a side thereof basically has a shape in which a trapezoid is laid on side and a front thereof has a rectangular shape (see, FIG. 28). In other words, the air inlet 2 has a substantially quadrangular pyramid shape with the one end portion 21 side being rectangular and the other end portion 22 being circular. However, the air inlet 2 is not limited to this shape, but may be any shape as long as the one end portion 21 of the air inlet 2 is wider than the other end portion 22 thereof. In other words, the air inlet 2 may be any shape as long as the one end portion 21 side of the air inlet 2 is formed larger than the other end portion 22 side thereof, and an inclined portion 23 is formed from the one end portion 21 to the other end portion 22. As a result, a larger amount of air can be taken from the one end portion 21 side of the air inlet 2. On the other hand, since the inclined portion 23 is formed from the one end portion 21 to the other end portion 22 of the air inlet 2, air can be easily guided from the one end portion 21 to the other end portion 22 of the air inlet 2. Accordingly, as long as the inclined portion 23 (FIG. 1) is formed from the one end portion 21 of the air inlet 2 to the other end portion 22 thereof, a cross-sectional shape of the air inlet 2 along the direction crossing the direction of the center axis is not particularly limited. Thus, the air inlet 2 may be formed to have a conical shape with the one end portion 21 also being circular. With the above-described configuration, air reaching the one end portion 21 of the air inlet 2 (air containing water such as rain water) flows toward the other end portion 22 formed to be narrowed.

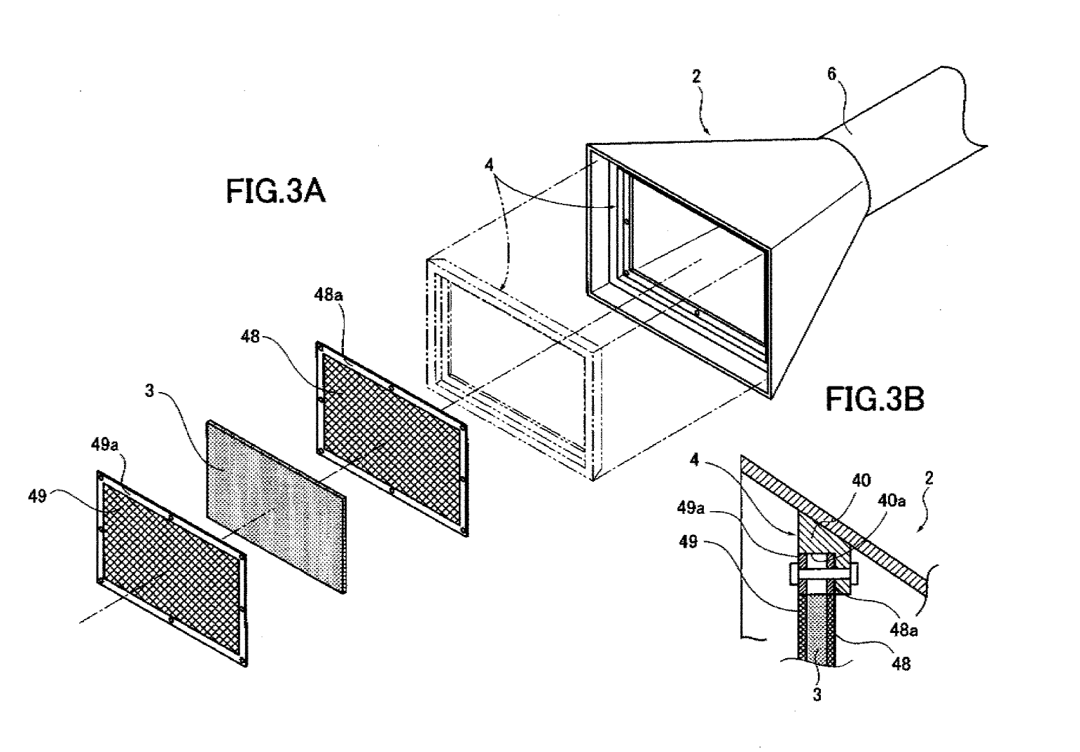

In this embodiment, as shown in FIGS. 3A and 3B, a filter 3 is set on the one end portion 21 side of the air inlet 2. The filter 3 has a function to prevent rain (water), dust, or other foreign substances from being taken from the air inlet 2. For example, this filter is fixed in the air inlet 2 by a filter fixing mechanism 4, The filter fixing mechanism 4 includes a fixing frame 40 to be fixed inside the air inlet 2. The fixing frame 40 has a groove portion 40a to accommodate a filter or the like. The fixing frame 40 has a shape corresponding to an inclined inner wall of the air inlet 2 (see, FIG. 3A and FIG. 3B). For example, the filter fixing mechanism 4 has a structure to fix the filter 3 by holding the filter 3 between first and second net members 48, 49 (see, FIG. 3B). The filter 3 has a mesh with a size suitable for preventing dust in air from being taken into the air inlet 2. The first and second net members 48, 49 are to fix the filter 3 in the air inlet 2, and the mesh thereof is set to be coarse than the mesh of the filter. Attaching frames 48a, 49a are respectively fixed around the first and second net members 48, 49.

When the filter 3 is fixed in the air inlet 2, the fixing frame 40 is firstly fixed inside the air inlet 2 by an arbitrary method, for example, welding, adhesion, or bonding. Of course, it may be fixed by an arbitrary mechanical method such as a bolt. The first net member 48 is disposed inside the groove portion 40a of the fixing frame 40, and then the filter 3 is disposed in the groove portion 40a of the fixing frame 40 on the first net member 48, and, thereafter, the second net member 49 is disposed inside the groove portion 40a of the fixing frame 40 on the filter 3. Then, the attaching frames 48a, 49a of the first and second net members 48, 49 are fixed to the fixing frame 40 by the bolts. In this manner, the filter 3 is firmly fixed in the air inlet 2 by holding it between the first and second net members, so that when air is introduced into the air inlet 2, foreign substances such as dust or insects are prevented from entering the air inlet 2. Water such as rainwater may be also prevented to some extent from entering the air inlet 2. It is preferable that a size of the mesh of the filter 3 be designed in consideration of a smallness of dust to be eliminated. Note that the filter 3 may be fixed by not only the filter fixing mechanism 4 but also by other various fixing mechanisms.

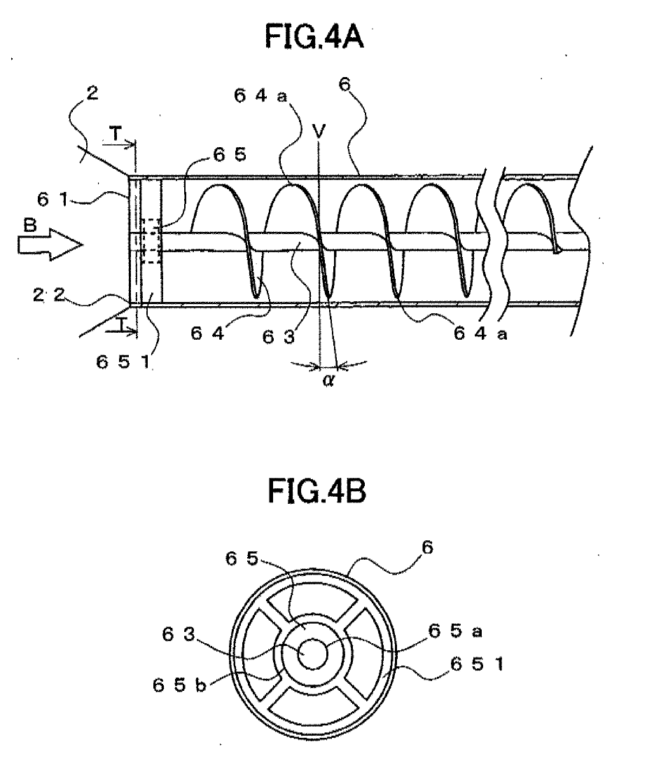

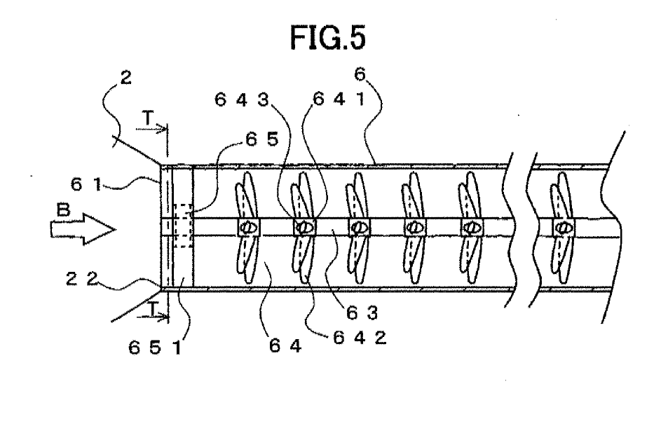

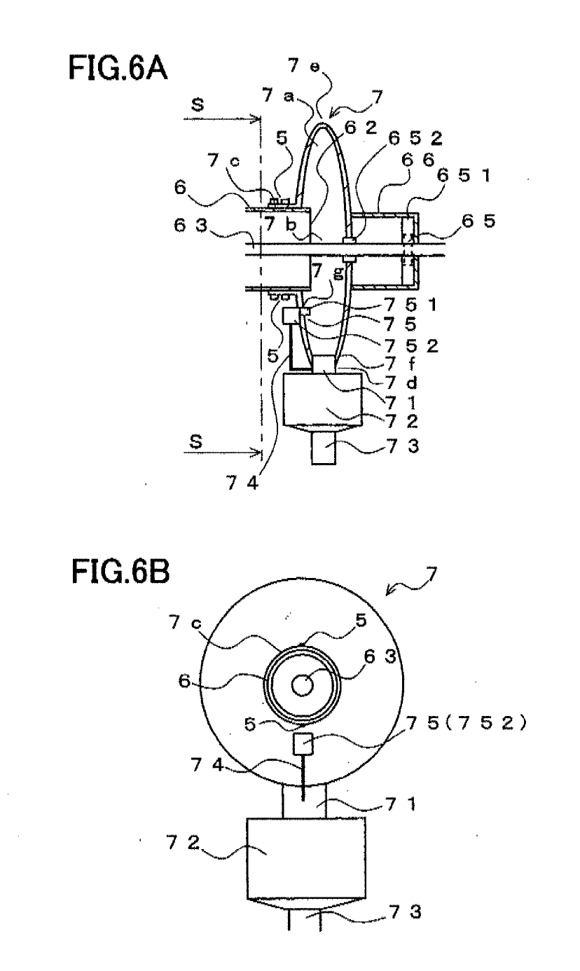

As shown in FIG. 1, the air introducing member 6 being a circular cylinder member is connected with the air inlet 2 with the above-described configuration. In this embodiment, the other end portion 22 of the air inlet 2 and one end portion 61 of the air introducing member 6 are connected with each other by welding, but they may be connected by other methods. In this embodiment, the air introducing member 6 is made of any metal, but is not particularly limited to be made of a metal but may be made of a resin. When the air introducing member 6 is a resin member, the connection with the air inlet 2 is not made by welding. For example, a portion where the other end portion 22 of the air inlet 2 and the one end portion 61 side of the air introducing member 6 are placed on top of each other is provided, and a fixing member such as a bolt is attached in the portion. Accordingly, the air inlet 2 and the air introducing member 6 can be connected with each other. Also, the air inlet 2 and the air introducing member 6 are not limited to be connected by attaching the fixing member such as a bolt, but they can be connected by applying an adhesive onto the portion where they are placed on top of each other. As shown in FIG. 4A, a rotatable shaft portion 63 is inside the air introducing member 6, and on the one end portion 61 side of the air introducing member 6, a bearing 65 is attached to rotatably supporting the shaft portion 63. Also, as shown in FIG. 6A, the bearing 65 is attached inside the supporting portion 66 on the other end portion 62 side of the air introducing member 6 to rotatably support the shaft portion 63.

The bearing 65 supporting the shaft portion 63 forms a disc-like shape, as shown in FIGS. 4A and 48, and is supported by inserting the shaft portion 63 into a center hole 65a of the disc-like shape. In this embodiment, a seal bearing is formed in the bearing 65 for preventing the bearing 65 from rusting due to air (air containing water such as rainwater) inflow from the air inlet 2. However, as long as the bearing 65 can prevent from rusting, it is not limited to the seal bearing. The bearing 65 is set inside a bearing fixing member 651 and the bearing 65 (the outer periphery 65b thereof) is supported by the bearing fixing member 651, and then, as shown in FIG. 4B, the bearing fixing member 651 is set inside a fan cylinder portion 66 (on the one end portion 61 side of the air introducing member 6) and is fixed inside the air introducing member 6. Also, on the other end portion 62 side of the air introducing member 6, as shown in FIG. 6A, as similar to FIGS. 4A and 4B, the bearing 65 in which the shaft portion 63 is set and the bearing fixing member 651 are fixed inside the cylinder portion 66. However, since the bearing 65 and the bearing fixing member 651 are stored inside the supporting portion 66 attached in the drain chamber 7, a possibility of rusting is lower as compared with a case of the bearing 65 and the bearing fixing member 651 on the one end portion 61 side of the air introducing member 6. For this reason, a ball bearing may be used. The bearing 65 stores an unillustrated ball to secure rotation of the shaft portion 63.

A power generator driving mechanism is provided in the air introducing member 6. This power generator driving mechanism has, for example, a shaft portion 63 and a fan blade portion 64 formed in a spiral manner on the shaft portion 63. The fan blade portion 64 is formed of a thin plate member, as shown in FIG. 4A, air (air containing water such as rainwater) flows into the air introducing member 6 and the air (the air containing water such as rainwater) hits the fan blade portion 64 to cause the shaft portion 63 to rotate. For this reason, as shown in FIG. 4A, the fan blade portion 64 has an inclination (an angle α) with respect to the straight line V crossing the longitudinal direction of the shaft portion 63 (the straight line in the direction perpendicular to the longitudinal direction), and the fan blade portion 64 is formed so as to have a concave surface with respect to the direction shown by an arrow B from which the air (the air containing water such as rainwater) flows in. In this embodiment, the fan blade portion 64 is formed in a spiral manner around the shaft portion 63 in order to achieve the inclination (the angle α) with respect to the direction crossing the longitudinal direction of the shaft portion 63 (the direction perpendicular to the longitudinal direction) and the concave surface. In addition, a tip end portion 64a side of the fan blade portion 64, which is the nearest to the air introducing member 6, has, for example, an arc-like shape. With the above-described configuration, the air (the air containing water such as rainwater) enters from the air inlet 2 side (along the direction shown by the arrow B) and the air (the air containing water such as rainwater) enters the air introducing member 6 and touches the spiral blade portion being the fan blade portion 64 to move the spiral blade portion, which results in causing the shaft portion 63 to rotate. Note that in this embodiment, the shaft portion 63 and the fan blade portion 64 are made of a resin member. However, the member is not particularly limited to a resin member but as long as it is light like aluminum, a metal member may be used.

Note that the fan blade portion 64 in this embodiment is not limited to have a spiral shape, but the fan blade portion 64 may be formed by using a propeller, for example. In other words, as generally known, the propeller has multiple blade portions 642 formed from the center portion 641 of the propeller as shown in FIG. 5, and, in order to cause the propeller to rotate when the air (the air containing water such as rainwater) hits the propeller, each blade portion 642 is twistedly formed toward the tip end 643 side of the blade portion 642 from the center portion 641 of the propeller. The air (the air containing water such as rainwater) hits the propeller to cause rotation, and then generate power. To form the fan blade portion 64 by the propeller functioning as a fan, multiple propellers are disposed at intervals in the shaft portion 63 (see, FIG. 5). The multiple propellers are disposed as described above, so that when the air (the air containing water such as rainwater) flows into the air introducing member 6 from the direction shown by the arrow B, the propellers start rotating sequentially from one near the one end portion 61 side of the air introducing member 6 to cause the shaft portion 63 to rotate. As shown in FIG. 5, a number of propellers are formed along the longitudinal direction of the shaft portion 63. Accordingly, as compared with the case where only a few propellers are partially attached to the shaft portion 63, a torque to be applied to the shaft portion 63 becomes larger and thus causes the shaft portion 63 to rotate faster. The rotation of the shaft portion 63 rotates a power generator rotational shaft portion 121 connected with the shaft portion 63 through a joint 11 as shown in FIG. 1, which causes the power generator 12 to generate power. The generated power is sent to a battery 14 with an electric power cable 13 and the power is stored in the battery 14. Also, as described above, even in the case where the fan blade portion 64 is formed of the propellers, as similar to the shaft portion 63 in which the fan blade portion 64 shown in FIGS. 4A and 4B is formed, the shaft portion 63 is supported by the bearing 65 and the bearing fixing member 651.

As shown in FIG. 1 and FIGS. 6A and 6B, a drain mechanism to discharge air is provided on the other end portion 62 side of the air introducing member 6. The drain mechanism has a drain chamber 7. In one embodiment, the drain chamber 7 has, for example, an elliptical rotating body, as shown in FIG. 1, FIGS. 6A, 6B, FIGS. 7A, 7B, and FIGS. 8A, 8B and 8C with an inner wall facing the air outlet being outwardly curved and bulged. Note that the supporting portion 66 is attached to the drain chamber 7. The drain chamber 7 basically includes a hollow portion 7a, and has the hollow portion 7a and a central hole 7b which is continuous from the hollow portion 7a and passes through the center portion to be the direction of the center axis of the drain chamber 7. The entire shape of the drain chamber 7 is not particularly limited. The inner surface of the drain chamber 7 may be subjected to corrosion prevention treatment with a waterproof coating material for preventing corrosion due to rainwater or the like from occurring. As described above, in this embodiment, as an example, as shown in FIGS. 6A and 6B, the shape is an elliptical rotating body which has an elliptical shape from the side thereof (see, FIG. 6A) and has a circular shape from the front thereof (see, FIG. 6B).

As described above, the drain chamber 7 has a cross-sectional area (or volume) larger than an opening area of the air outlet, i.e., the opening area of the other end portion 62 of the air introducing member 6. Also, in this embodiment, a frame portion 7c continuous with the drain chamber 7 is formed on the other end portion 62 side of the air introducing member 6 adjacent to the central hole 7b passing through the center of the drain chamber 7 (formed along the center axial direction of the drain chamber). As shown in FIG. 6A, the frame portion 7e has a cylindrical shape and is formed to be mounted on the outer periphery of the air introducing member 6. The other end side 62 side of the air introducing member 6 is set in the frame portion 7c, so that the drain chamber 7 and the air introducing member 6 are connected with each other. When the drain chamber 7 and the air introducing member 6 are connected, the drain chamber 7 and the air introducing member 6 are fixed by using a plurality of bolts 5, in this embodiment, two bolts side by side along the air introducing member 6 as shown in FIG. 6A. Here, the drain chamber 7 as a space with a cross-sectional area or volume larger than the opening area of the air outlet of the air introducing member 6 as shown in FIG. 1 and FIG. 6A. With such a configuration, when the air flows into the drain chamber 7 from the air outlet of the air introducing member 6, the air is expanded to reduce the speed and lose stream.

Accordingly, the bolts 5 are fixed side by side, so that the strength of the connection between the drain chamber 7 and the air introducing member 6 can be increased and the rotating shaft portion 63 can be supported by the bearing 65. Also, in this embodiment, the bolts 5 are fixed in two positions facing each other at 180°, but the positions are not limited to the positions facing each other at 180°, but may be four positions at every 90°. In addition, on the side of the central hole 7b of the drain chamber 7, which is opposite to the side on which the frame portion 7c is formed, as shown in FIG. 6A, a seal member 652 for preventing water leakage from the drain chamber 7 is fitted in the center hole 7b and is fixed inside the central hole 7b with an adhesive or the like. The seal member 652 has a ring shape and the shaft portion 63 is rotatable against the seal member 652 by setting the shaft portion 63 in the center hole of the seal member 652 and causing the seal member 652 to pass through the shaft portion 63. In this embodiment, a resin seal with small attrition is used as the seal member 652. However, as long as the water leakage prevention from the drain chamber 7 and the rotatable state of the shaft portion 63 can be secured, a seal member of another material can be used.

The supporting portion 66 is attached to the drain chamber 7, which faces the air introducing member 6 across the drain chamber 7. The drain chamber 7 and the supporting portion 66 are connected by welding in this embodiment. However, it is not particularly limited to the welding. As similar to the connection with the air introducing member 6, it is also possible to form a frame portion in the drain chamber 7, and to fit the supporting portion in the frame portion to fix the fixing member 5 such as bolts. In this embodiment, the supporting portion 66 is a member having a cylindrical shape. However, the shape is not particularly limited to the cylindrical shape, and a prismatic member such as a quadratic prism can be also used. The shape of the supporting portion 66 is not limited, and may be any shape as long as the bearing 65 rotatably supporting the shaft portion 63 and the bearing fixing member 651 are stored.

As shown in FIG. 6A, on the lower end portion 7d of the drain chamber 7 in the drain chamber 7, a blower fan storage case 71 is attached. An opening portion 7f is formed on the one end portion 7d side of the drain chamber 7 and the blower fan storage case 71 in which a blower fan (not shown) is stored is attached on the lower end portion 7d side of the drain chamber 7 so as to face the hollow portion 7a inside the drain chamber 7. Note that the blower fan has a regular form. Also, in this embodiment, the outer shape of the blower fan storage case 71 has a short quadrangular prism shape as a whole as shown in FIG. 6A.

The blower fan storage case 71 is continuous with the hollow portion 7a of the drain chamber 7 and water (content) and air of the hollow portion 7a are discharged from the drain chamber 7. A drain box 72 is continuously attached to the blower fan storage case 71. In this embodiment, the blower fan storage case 71 has a quadrangular shape, and thus an entrance of the drain box 72 in which the blower fan storage case 71 is set also has a quadrangular shape to which the blower fan storage case 71 is set. Also, in this embodiment, the blower fan storage case 71 and the drain box 72 are connected with each other by welding. However, in consideration of maintenance or the like, the blower fan storage case 71 and the drain box 72 may be detachably attached to each other. For example, a flange portion (an edge portion) is formed on the drain box 72 side in the blower fan storage case 71, and the flange portion (the edge portion) of the blower fan storage case 71 is brought into contact with the entrance side of the drain box 72 through an unillustrated packing, so that the flange portion (the edge portion) of the blower fan storage case 71 is attached to the drain box 72 by fixing members such as bolts. The drain box 72 is a box provided for discharging water (content) and air flew from the blower fan storage case 71 and is communicated with the blower fan storage case 71. Then, a discharge port 73 to discharge the water (content) and air in the drain box extends from the drain box 72. On the discharge port 73 side of the drain box 72, as shown in FIG. 6B, a slope is formed toward the discharge port 73 so as to particularly facilitate the discharge of water (content) which is discharged from the drain box 72 to the discharge port 73.

The blower fan inside the blower fan storage case 71 is controlled by a pressure sensor 75. The pressure sensor 75 is, as shown in FIGS. 6A and 6B, attached to the drain chamber 7. The position where the pressure sensor 75 is attached is not particularly limited. However, since signals are to be transmitted to the blower fan inside the blower fan storage case 71, in order to prevent a signal cable 74 connecting between the blower fan inside the blower fan storage case 71 and the pressure sensor 75 from being elongated, the pressure sensor 75 is attached to a position near the blower fan inside the blower fan storage case 71. In this embodiment, as shown in FIG. 6A, the pressure sensor 75 is attached on the drain chamber 7 (on the elliptical circular portion of the drain chamber 7) between the frame portion 7c of the drain chamber 7 and the blower fan storage case 71 attached to the drain chamber 7. Specifically, the pressure sensor 75 is attached on the lower end portion 7d side of the drain chamber 7 and on the air introducing member 6 side of the drain chamber 7. However, for example, on the side of the drain chamber 7 shown in FIG. 6A, the pressure sensor 75 may be attached on the drain chamber 7 (on the elliptical circular portion of the drain chamber 7) in a position facing the pressure sensor 75 shown in FIG. 6A and between the seal member 652 and the blower fan storage case 71. The pressure sensor 75 includes an amplifier 752 and a sensor 751. The amplifier 752 and the sensor 751 are connected adjacent to each other, and signals from the sensor 751 are sent to the blower fan with the signal cable 74 via the amplifier 752.

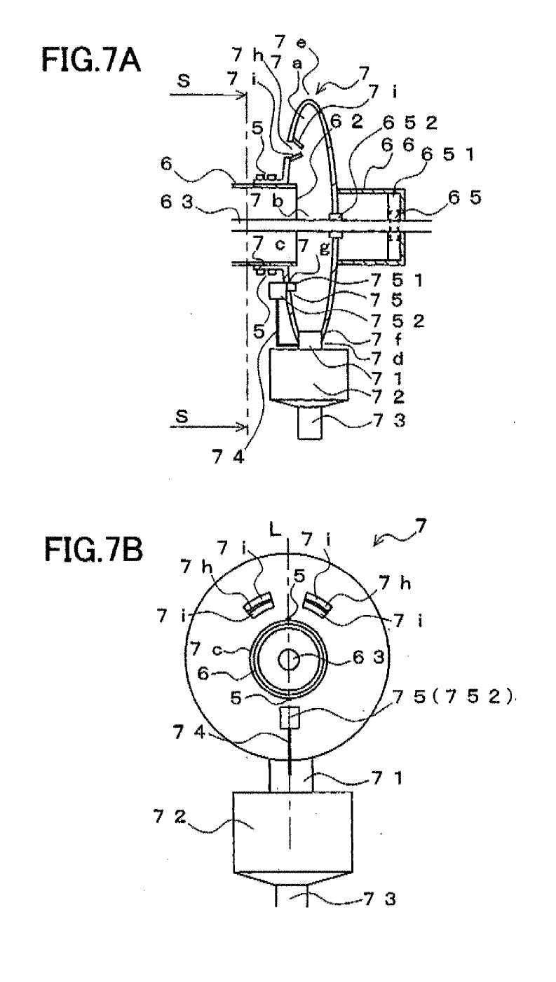

Also, in the drain chamber 7 shown in FIGS. 7A and 7B, the pressure sensor 75 is attached on the drain chamber 7 (on the elliptical circular portion of the drain chamber 7) between the frame portion 7c of the drain chamber 7 and the blower fan storage case 71 attached to the drain chamber 7. Specifically, the pressure sensor 75 is attached on the one end portion 7d side of the drain chamber 7 and on the air introducing member 6 side in the drain chamber 7 (see, FIG. 7A). This is to prevent the pressure sensor 75 from wrongly operating due to the adhesion of water such as rainwater to the pressure sensor 75 when air containing water such as rainwater (the air containing water such as rainwater) from the air introducing member 6 rushes to the drain chamber 7. The pressure sensor 75 is attached to a position on the one end portion 7d of the drain chamber 7 and on the air introducing member 6 side in the drain chamber 7, where the water such as rainwater is difficult to adhere to the pressure sensor 75.

For this reason, the pressure sensor 75 is required to detect a pressure inside the drain chamber 7, and the sensor 751 is set inside a hole portion 7g formed in the drain chamber 7 for the detection. In other words, the pressure sensor 75 is attached inside the drain chamber 7. In this embodiment, to keep preventing water leakage from the drain chamber 7 from occurring, a member similar to the seal member is set in the hole portion 7g together with the sensor 751 to fix the sensor 751 therein when the sensor 751 is set in the hole portion 7g of the drain chamber 7. Then, the amplifier 752 connected with the sensor 751 is disposed on the drain chamber 7. Since the sensor 751 is fixed in the hole portion 7g of the drain chamber 7, the amplifier 752 is not necessarily fixed on the drain chamber 7. However, when fixed, the amplifier 752 is fixed on the drain chamber 7 by an adhesive or by an amplifier storage case in which the amplifier is stored. In this embodiment, the pressure sensor 75 is configured by connecting the amplifier 752 and the sensor 752 with each other. However, the configuration is not necessarily limited to the configuration in which the amplifier 752 and the sensor 751 are connected with each other. For example, there is another possible configuration in which the amplifier 752 is disposed in a position far from the sensor 751 and the sensor 751 and the amplifier 752 are connected by a signal line.

The foregoing description is mainly about the drain chamber 7 and the configuration on the other end portion 62 side of the air introducing member 6 in this embodiment. However, the drain chamber 7 may use the configuration shown in FIGS. 7A and 7B. The configuration of the members in FIGS. 7A and 7B is same as the configuration of the members except the drain chamber 7 in FIG. 6. The drain chamber 7 shown in FIGS. 7A and 7B generally has an elliptical rotating body shape, as similar to FIGS. 6A and 6B. However, two discharge ports 7h are formed on the other end portion 7e side of the drain chamber 7 and on the air introducing member 6 side. In other words, as shown in FIG. 78, the discharge ports 7h, 7h are formed in a shape near the longitudinal shape in positions symmetrical across the straight line passing through the center of the longitudinal direction of the drain chamber 7. The shape of the discharge port 7h is not limited to a rectangular shape such as a rectangle and may be formed only by a curved line such as a circle. Also, the number of the discharge ports 7h is not limited to two, and the number of the discharge ports may be two or more. For example, a discharge port can be formed on the straight line L shown in FIG. 7B and between the two discharge ports 7h, 7h. Accordingly, the size and number of the discharge ports are not particularly limited. By forming such a discharge port 7h, in a case where an amount of air (air containing water such as rainwater) entering from the air inlet 2 through the air introducing member 6 is larger than that of air (air containing water such as rainwater) coming out from the discharge port 73 on the blower fan storage case 71 side, if the air comes out from this discharge port 7h, the fluidity of the air (the air containing water such as rainwater) entering from the air inlet 2 is not damaged. Accordingly, the flow of the air (the air containing water such as rainwater) from the air inlet 2 to the air introducing member 6 is facilitated.

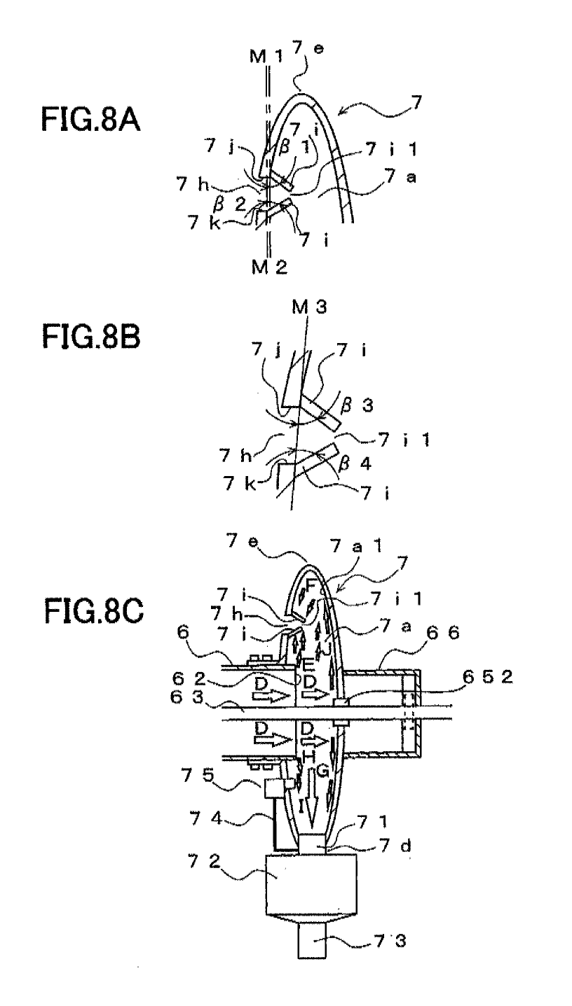

Also, in the drain chamber 7 shown in FIGS. 7A and 7B, a water splattering prevention device is provided for preventing water from entering the discharge port 7h. The water splattering prevention device is formed of, for example, a water splattering prevention plate 7i provided in the discharge port. The size of the water splattering prevention plate 7i may be basically any size as long as it can cover the discharge port 7h. The shape of the water splattering prevention plate 7i is not particularly limited, but basically has a shape similar to the shape of the discharge port 7h. The discharge port 7h of the drain chamber 7 shown in FIGS. 7A and 7B has a shape similar to a rectangle. Accordingly, the water splattering prevention plate 7i also has a shape similar to a rectangle. As shown in FIG. 7A, the water splattering prevention plate 7i is attached to the discharge port 7h. Specifically, the water splattering prevention plate 7i is attached to be protruded toward the inside of the drain chamber 7 along the edge portions 7j, 7k of the discharge port 7h as shown in FIG. 8A. The edge portions 7j, 7k on the discharge port 7h are positioned so as to face each other. The water splattering prevention plate 7i is attached in the edge portions 7j, 7k inside the drain chamber 7, and thus the water splattering prevention plates 7i, 7i are attached on the discharge port 7h side in an inclined manner.

In FIG. 7A and the like, the water splattering prevention plates 7i, 7i are attached in the vertical direction of the discharge port 7h along the longitudinal direction of the drain chamber 7. Specifically, as shown in FIG. 5C, the water splattering prevention plates 7i, 7i are attached to the edge portion 7k on the other end portion 62 side of the air introducing member 6, which is inside the end portion of the discharge port 7h and an edge portion near the other end portion 62 side of the air introducing member 6 and to the edge portion 7j which faces the edge portion 7k and is an edge portion on the other end portion 7e side of the drain chamber 7. The water splattering prevention plate 7i is attached to the edge portion 7k of the discharge port 7h, so that air (air containing water such as rainwater) from the other end portion 62 side of the air introducing member 6 comes in touch (collides) with the water splattering prevention plate 7i. Also, the water splattering prevention plate 7i is attached to the edge portion 7j facing the edge portion 7k of the discharge port 7h, so that air (air containing water such as rainwater) from the other end portion 7e side of the drain chamber 7 comes in touch (collides) with the water splattering prevention plate 7i.

The water splattering prevention plate 7i may be attached by an adhesive or welding. When the water splattering prevention plate 7i is made of a metal and the drain chamber 7 is also made of a metal, welding is performed. The water splattering prevention plate 7i is attached to the edge portion 7j of the discharge port 7h as shown in FIG. 8A so as to make an angle β1 with respect to the straight line M1 which intersects with the direction of the center axis of the drain chamber 7 and along the axial line in the longitudinal direction of the drain chamber 7. Also, the water splattering prevention plate 7i is attached to the edge portion 7k of the discharge port 7h as shown in FIG. 8A so as to make an angle β2 with respect to the straight line M2 which intersects with the direction of the center axis of the drain chamber 7 and along the longitudinal direction of the drain chamber 7. In FIGS. 7A and 7B (FIGS. 8A to 8C), the angle β1 is 45° and the angle β2 is 50°, but they may be any acute angle without being limited to 45° and 50°. Also, in this embodiment, the angle β1 and the angle β2 are different angles, but may be a same angle. As described above, by setting the angle β1 and the angle β2 as acute angles, it is only needed that each of the water splattering prevention plates 7i, 7i eventually makes an acute angle with respect to the straight line M3 (with respect to the discharge port 7h) connecting between the end portions of the edge portions 7j, 7k of the discharge port 7h inside the drain chamber 7.

As shown in FIG. 8B, the water splattering prevention plates 7i, 7i respectively make angles β3, β4 which are acute angles with respect to the discharge port. The angles β3, β4 of the water splattering prevention plates 7i, 7i with respect to the discharge port 7h are different in FIG. 5B, but may be same. Since the water splattering prevention plates 7i, 7i make the angles β3, β4 with respect to the discharge port 7h, the water splattering prevention plates 7i, 7i are inclined to the discharge port 7h side. Since the water splattering prevention plates 7i, 7i make acute angles with respect to the discharge port 7h as described above, even when water such as rainwater which is carried together with air (air containing water such as rainwater) inside the air introducing member 6 to the drain chamber 7 collides with the other end portion 62 side (inside the drain chamber 7) of the air introducing member 6 and gets splashed toward the discharge port 7h, the water collides with the water splattering prevention plates 7i, 7i. Accordingly, the water such as rainwater inside the drain chamber 7 can be prevented from coming out form the discharge port 7h.

The drain chamber 7 has an elliptical shape, but the shape thereof is not limited. The following shape may be given as a shape which is the most possibly used for keeping water such as rainwater contained in the air (the air containing water such as rainwater) taken from the air inlet 2 without leaking to the vehicle from the wind power generating apparatus 1.

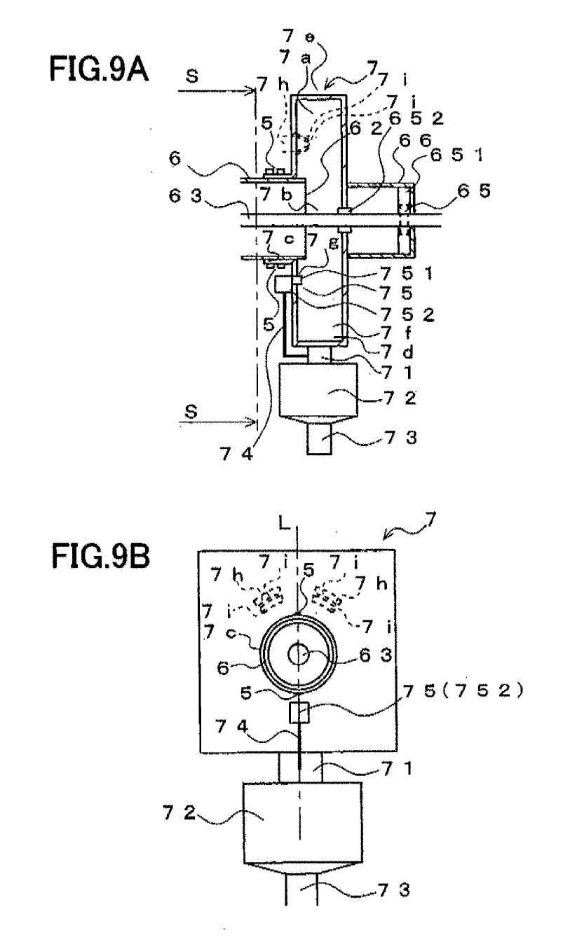

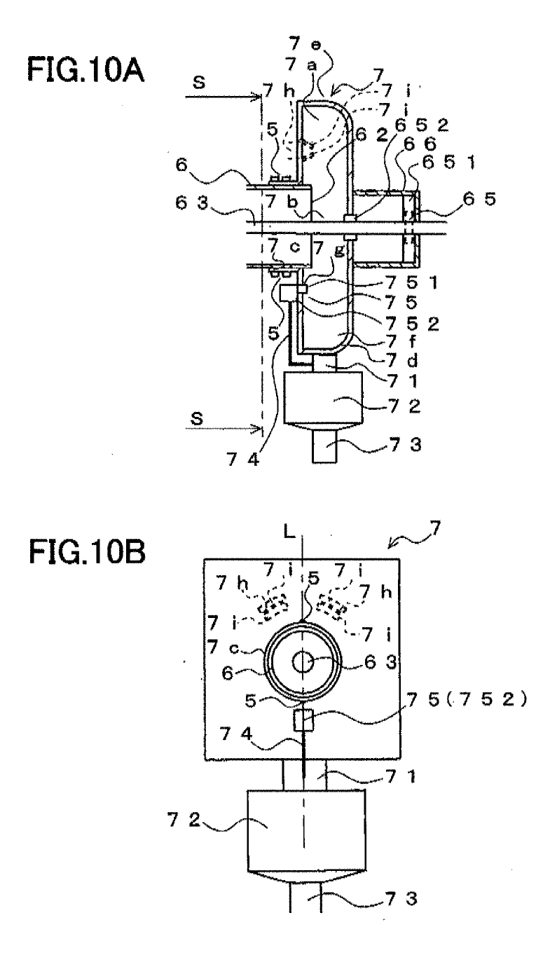

The drain chamber 7 shown in FIGS. 9A and 9B is not an elliptical rotating body as described above but has a hollow quadrangular prism shape. The drain chamber 7 shown in FIGS. 10A and 10B has a substantially hollow quadrangular prism shape as similar to the quadrangular prism body shown in FIGS. 9A and 9B, and has an elongated semi-circular portion 7e formed behind in a ridge line. The drain chamber 7 has an air outlet of the air introducing member 6 and a space with a cross-sectional area or volume larger than the opening area of the end portion 62 as similar to the foregoing description. FIGS. 9A and 9B and FIGS. 10A and 10B are different from FIGS. 6A and 6B in the outer shape of the drain chamber 7, and the other portions are all same as in FIGS. 6A and 6B.

The shaft portion 63 extending from the supporting portion 66 connected with the above-described drain chamber 7 is connected with a shaft portion 121 of the power generator 12 through the joint 11, as shown in FIG. 1. In addition the power generator 12 and the battery 14 are connected with each other by the electric power cable 13. The wind power generating apparatus 1 with the above-described configuration is mounted inside the automobile 10. A specific example how the wind power generating apparatus 1 is mounted inside the automobile 10 is shown in FIGS. 11A and 118. In FIGS. 11A and 11B, the wind power generating apparatus 1 is mounted on the front side of the automobile 10 and the air inlet 2 is disposed in the front center of the automobile 10 so that air (air containing water such as rainwater) is taken to the one end portion 21 side of the air inlet 2 from the direction shown by the arrow B when the automobile 10 runs in the direction shown by the arrow C. Then, as shown in FIG. 11A, the air introducing member 6 connected with the air inlet 2 is disposed along the direction of the center axis N of the automobile 10 and the drain chamber 7 is connected with the air introducing chamber 6 disposed along the direction of the center axis N of the automobile 10. Also, as shown in FIG. 11B, the blower fan 71 is attached on the one end portion 7d side of the drain chamber 7 and the drain box 72 and the discharge port 73 are continuously attached to the blower fan storage case 71.

As shown in FIG. 11B, the discharge port 73 is attached to the floor surface 102 of the vehicle (the automobile 10). A hole portion 103 passing through the floor surface 102 of the vehicle (the automobile 10) to which the discharge port 73 is attached is formed and the discharge port 73 is in communication with an outside of the vehicle (the automobile 10).

However, the discharge port 73 does not necessarily surround the hole portion 103, and the discharge port 73 may be set inside the hole portion 103. In addition, although it is not illustrated in the drawing, when the discharge port 73 is attached to the floor surface 102 of the vehicle (the automobile 10), a flange portion (an edge portion) extending in a direction perpendicular to the direction of the center axis of the discharge port 73 is formed at the end portion of the discharge portion 73 on the floor surface 102 side of the vehicle (the automobile 10), and a bolt is set in from the flange portion side coming in touch with the floor surface 102 of the vehicle (the automobile 10) to connect between the discharge port 73 and the floor surface 102 of the vehicle (the automobile 10). However, the connection method is not limited to one in which the flange portion (the edge portion) is formed to set a bolt therein, and the discharge port 73 and the floor surface 102 of the vehicle (the automobile 10) may also be connected with each other by a method such as welding.

As described above, the discharge port 73 is disposed so as to face the outside of the vehicle from the floor surface 102 on the wheel 101 side of the vehicle (the automobile 10), and thus air (air containing water such as rainwater) and water such as rainwater can be discharged to the outside of the vehicle (the automobile 10). Furthermore, the configuration is such that the joint 11 connecting between the shaft portion 63 and the shaft portion 121 along the direction of the center axis N of the automobile 10 and the power generator 12 connected with the shaft portion 121 are attached from the supporting portion 66 continuous to the drain chamber 7. The power generator 12 is connected with the battery 14 through the electric power cable 13 on one wheel 101 side in the vehicle width direction of the automobile 10.

When the automobile 10 runs in the direction shown by the arrow C, air (air containing water such as rainwater) is taken to the air inlet 2. The air contains not only water such as rainwater but also foreign substances such as dust and insects, but the foreign substances are prevented from entering by the filter 3 attached to the one end portion 21 side of the air inlet 2. Then, the air (the air containing water such as rainwater) having passed through the filter 3 passes inside the air inlet 2 and enters the air introducing member 6 connected with the other end portion 22 of the air inlet 2. The air (the air containing water such as rainwater) having entered the air introducing member 6 collides with the curved surface of the fan blade portion 64 formed in the shaft portion 63 and flows to come in continuous touch with the fan blade portion 64 formed along the longitudinal direction of the shaft portion 63, so that the shaft portion 63 is rotated.

As shown in FIG. 5, as compared with the case where the fan blade portion 64 is formed at intervals in the longitudinal direction of the shaft portion 63, the torque to be applied to the shaft portion 63 becomes larger to cause the shaft portion 63 to rotate faster (see, FIG. 4A). The rotation of the shaft portion 63 causes the shaft portion 121 of the power generator connected with the shaft portion 63 through the joint 11 to rotate, which causes power generation by the power generator 12. The generated power is sent to the battery 14 with the electric power cable 13 and the power is stored in the battery 14. Then, the power stored in the battery 14 is supplied to an unillustrated driving motor of a vehicle (an electric vehicle, HEV, or the like) or other electrical systems of the automobile 10.

The air (the air containing water such as rainwater) having passed through the inside of the air introducing member 6 reaches the hollow portion 7a formed inside the drain chamber 7 (see FIGS. 6A and 6B, and FIGS. 11A and 11B). The air (the air containing water such as rainwater) having reached the hollow portion 7a is quickly discharged (from the hole portion 3) to the outside of the vehicle (outside of the automobile 10) after passing the drain chamber 7, the drain box 72 and the discharge port 73 sequentially from the blower fan storage case 71 (see FIGS. 6A and 6B, and FIGS. 11A and 11B). The flow of the air having passed through the air introducing member 6 is weakened when entering the drain chamber. This is, as described above, because the drain chamber has a cross-sectional area or volume larger than the opening area of the discharge port of the air introducing member 6.

The foregoing description is the flow of the air (the air containing water such as rainwater) passing through the inside of the wind power generating apparatus 1. When the pressure sensor is used, a significant amount of air (air containing water such as rainwater) enters the drain chamber after having passed the air inlet 2 and the air introducing member 6 when the automobile 10 runs at a higher speed. When the sensor portion 751 of the pressure sensor 75 detects a change in pressure of the air having entered the drain chamber 7, signals are sent from the sensor portion 751 to the amplifier 752 and the signals having passed the amplifier 752 are set to the blower fan storage case 71 through the signal cable 74 to activate (rotate) the blower fan. Since the blower fan inside the blower fan storage case 71 is activated (rotated), the air (the air containing water such as rainwater) inside the hollow portion 7a moves in the direction in which the air is sucked into the blower fan storage case 71 side, and the air (the air containing water such as rainwater) inside the drain chamber 7 is discharged to the outside of the vehicle (the outside of the automobile 10) from the discharge port 73 (from the hole portion 103) after having passed from the blower fan storage case 71 to the drain box 72, which results in pressure decrease inside the drain chamber 7. As a result, the air (the air containing water such as rainwater) passing through the air inlet 2 and the air introducing member 6 with a larger amount at a higher speed when the automobile 10 runs at a higher speed can be introduced into the drain chamber 7.

When the high-speed driving of the automobile 10 is stopped, the speed of the air (the air containing water such as rainwater) entering the drain chamber 7 shown in FIGS. 6A and 6B after having passed the air inlet 2 and the air introducing member 6 is reduced, and the amount of the air (the air containing water such as rainwater) is also reduced, which results in reducing the pressure inside the drain chamber 7 from the higher state to a lower state. The air inside the drain chamber 7 is sucked by the blower fan 71, and the pressure inside the drain chamber 7 is reduced. When the sensor 751 detects this state (the state in which the pressure inside the drain chamber 7 returned to the state before the pressure change), the signals to the amplifier 752 are stopped. Thus, the signals are not sent to the blower fan inside the blower fan storage case 71 through the signal cable 74, which results in stopping the blower fan. Even when the blower fan stops, the water such as rainwater contained in the air (the air containing water such as rainwater) entering the drain chamber 7 is discharged to the outside of the vehicle (the outside of the automobile 10) from the discharge port 73 (from the hole portion 103) after having passed from the blower fan through the drain chamber 7 to the drain box 72. This is the treatment of the air (the air containing water such as rainwater) entering the drain chamber 7 inside the drain chamber 7 in FIGS. 6A and 6B.

Next, in FIGS. 7A and 7B different from FIGS. 6A and 6B, the description is given of treatment on air (air containing water such as rainwater) entering the drain chamber 7.

The basic operational state of the automobile 10 shown in FIGS. 11A and 11B, in which the movable object-mounted wind power generating apparatus 1 with the mechanism shown in FIGS. 7A and 7B is mounted, is same as the ease with the mechanism shown in FIGS. 6A and 6B, and the description is mainly given to different operations.

As shown in FIGS. 11A and 11B, when the automobile 10 runs in the direction shown by the arrow C, air (air containing water such as rainwater) is taken into the air inlet 2 from the direction shown by the arrow B. As similar to the case where the mechanism shown in FIGS. 6A and 6B, the air (the air containing water such as rainwater) in the direction shown by the arrow D in FIG. 8C reaches the inside of the drain chamber 7 after having passed through the air introducing member 6. The hollow portion 7a is formed inside the drain chamber 7 and water such as rainwater in the air (air containing water such as rainwater) passes through the inside of the drain chamber 7 (the hollow portion 7a) to flow to the discharge port 73. In other words, the air (the air containing water as rainwater) flows from the other end portion 62 of the air introducing member 6 in the direction shown by the arrow U to collide with the seal member 652 side of the drain chamber 7, and is divided into the directions shown by the arrows J and G, as shown in FIG. 8C, and from a position near the edge portion of the other end portion 62 of the air introducing member 6, the air flows again in the directions shown by the arrows E and H.

As described above, the water such as rainwater in the air (the air containing water such as rainwater) having reached the inside of the hollow portion 7a, moves to the blower fan side inside the drain chamber 7, which is provided just below in the vertical direction, by falling down on the wall surface 7a of the hollow portion 7a or dropping down. After having passed through the blower fan, the water enters the drain box 72 and then is discharged to the outside of the vehicle (outside of the automobile 10) through the discharge port 73 (from the hole portion 103) (see, FIG. 11B). Similarly, the air containing water such as rainwater, which has moved in the direction shown by the arrow G, among the air containing water such as rainwater which has passed through the air introducing member 6 and the air containing the air containing water such as rainwater, which has blown out in the direction shown by the arrow H is quickly discharged from the discharge port 73 (from the hole portion 103) to the outside of the vehicle (outside of the automobile 10) after passing from the blower fan storage case 71 to the drain box 72 through the drain chamber 7 (see, FIG. 11B).

Furthermore, the air containing water such as rainwater, which has collided with the seal member 652 side opposite to the air introducing member 6 partially moves in the direction shown by the arrow J and blows out in the direction shown by the arrow E from the position near the edge portion of the other end portion 62 of the air introducing member 6. The air containing water such as rainwater inside the drain chamber 7 is divided into water and air by the water splattering prevention plates 7i, 7i provided in the upper and lower sides of the discharge port 7h, and only the air is discharged from the discharge port 7h to the inside of the vehicle (the inside of the automobile 10), and finally goes out to the outside of the vehicle (the outside of the automobile 10). In other words, as shown in FIG. 8C, most of the air containing water such as rainwater which goes to the discharge port 7h goes from the direction shown by the arrow E or the direction shown by the arrow F and the air containing water such as rainwater collides with the water splattering prevention plates 7i, 7i. When colliding, the water such as rainwater in the air containing water such as rainwater adheres to the water splattering prevention plates 7i, 7i, so that the air except the water goes out from the gap 7i1 between the water splattering prevention plates 7i, 7i. The water such as rainwater, which has adhered to the water splattering prevention plates 7i, 7i falls down on the wall surface 7a1 of the hollow portion 7a of the water splattering prevention plates 7i, 7i or drops down to move to the blower fan storage case 71 side, and then the water is discharged to the outside of the vehicle (the outside of the automobile 10) from the discharge port 7h (from the hole portion 103) through the drain box 72 (see, FIG. 11B).

As similar to the case of FIGS. 6A and 6B, when the automobile 10 runs at a higher speed, the speed of the air (the air containing water such as rainwater) entering the drain chamber 7 shown in FIGS. 7A and 7B after having passed through the air inlet 2 and the air introducing member 6 is fast and the amount of the air (the air containing water such as rainwater) is also large. Since the discharge port 7h is formed in the drain chamber 7, the air (the air containing water such as rainwater) inside the drain chamber 7 is discharged from the discharge port 73 (through the hole portion 103). However, since a large amount of the air (the air containing water such as rainwater) enters the drain chamber 7, the pressure inside the drain chamber 7 increases. The sensor portion 751 of the pressure sensor 75 detects the change in the pressure. As similar to the case in FIGS. 6A and 6B, when the change in the pressure inside the drain chamber 7 (the pressure increase) is detected, signals are sent from the sensor portion 751 to the amplifier 752, and the signals after the amplifier 752 are sent to the blow fan in the blower fan storage case 71 through the signal cable 74 to activate (rotate) the blower fan. Since the blower fan is activated (rotated), the air (the air containing water such as rainwater) inside the hollow portion 7a moves in the direction in which the air is sucked into the blower fan side, and the air (the air containing water such as rainwater) inside the drain chamber 7 is discharged to the outside of the vehicle (the outside of the automobile 10) from the discharge port 73 (from the hole portion 103) after having passed from the blower fan to the drain box 72, which results in pressure decrease inside the drain chamber 7.

Specifically, as shown in FIG. 8C, the blower fan in the blower fan storage case 71 is activated (rotated) to move the air (the air containing water such as rainwater) having entered the hollow portion 7a of the drain chamber 7 in the direction shown by the arrow I and discharge the air to the outside of the vehicle (the outside of the automobile 10) from the discharge portion 73 (through the hole portion 103) after having passed through the blower fan and the drain box 72. Accordingly, the pressure inside the drain chamber 7 is decreased. At this time, the air (the air containing water such as rainwater) having entered the hollow portion 7a of the drain chamber 7 does not entirely move to the blower fan side. As similar to the case where the blower fan is not activated (rotated), the air (the air containing water such as rainwater) colliding with the side surface of the seal member 652 of the drain chamber 7 flows in the directions shown by the arrows J and G in the radial direction as shown in FIG. 8C. In addition, the air (the air containing water such as rainwater) also flows in the directions shown by the arrows E and H in the radial direction from the position near the edge portion of the other end portion 62 of the air introducing member 6. When the blower fan is activated (rotated), the air (the air containing water such as rainwater) inside the hollow portion 7a becomes easy to move to the blower fan side and the water such as rainwater runs and moves on the wall surface 7a1 of the hollow portion 7a to the blower fan side. The running speed and falling speed get faster, so that the air moves faster to the blower fan side, which is provided just below in the vertical direction and inside the drain chamber 7, as compared with the case where the blower fan is not activated (rotated).

The water such as rainwater enters the drain box 72 from the blower fan side, as similar to the case when the blower fan is not activated, and then discharged to the outside of the vehicle (the outside of the automobile 10) through the discharge port 72 (the hole portion 103). Furthermore, most of the air (the air containing water as rainwater) which goes from the direction shown by the arrow F to the discharge port 7h increases the speed by the operation (the rotation) of the blower fan and collides with the water splattering prevention plates 7i, 7i as shown in FIG. 5C. Also, the air (the air containing water as rainwater) which goes from the direction shown by the arrow E to the discharge port 7h collides with the water splattering prevention plate 7i. When colliding, the water in the air containing water such as rainwater adheres to the water splattering prevention plates 7i, 7i, so that the air except the water goes out from the gap 7i1 between the water splattering prevention plates 7i, 7i, and then the water is finally discharged to the outside of the vehicle (the outside of the automobile 10).

The water such as rainwater, which has adhered to the water splattering prevention plates 7i, 7i falls down on the wall surface 7a1 of the hollow portion 7a from the water splattering prevention plates 7i, 7i or drops down to move to the blower fan storage case 71 side which is provided just below in the vertical direction, and then the water enters the drain box 72 and is discharged to the outside of the vehicle (the outside of the automobile 10) through the discharge port 73 (from the hole portion 103). Accordingly, the water such as rainwater contained in the large amount of air (the air containing water such as rainwater) entering the drain chamber 7 even when the blower fan is being activated (rotated) by the pressure sensor 75 goes out from the discharge port 73 (through the hole portion 103) after having passed the drain box 72 from the drain chamber 7. In this manner, when the automobile 10 runs with a higher speed, the large amount of the air (the air containing water such as rainwater) is finally discharged at a higher speed to the outside of the vehicle (the outside of the automobile 10) through the air inlet 2, the air introducing member 6y and the drain chamber 7.

As similar to the case in FIGS. 6A and 6B, when the high-speed driving of the automobile 10 is stopped, the speed of the air (the air containing water such as rainwater) entering the drain chamber 7 after having passed the air inlet 2 and the air introducing member 6 is reduced, and the amount of the air is also reduced, which results in reducing the pressure inside the drain chamber 7. When the sensor 751 detects that the pressure inside the drain chamber 7 is decreased (that the pressure inside the drain chamber 7 returned to the state before the pressure change), the signals to the amplifier 752 are stopped. Thus, the signals are not sent to the blower fan inside the blower fan storage case 71 through the signal cable 74, which results in stopping the blower fan. Even when the blower fan stops, the water such as rainwater contained in the air (the air containing water such as rainwater) entering the drain chamber 7 is discharged to the outside of the vehicle (the outside of the automobile 10) from the discharge port 73 (from the hole portion 103) after having passed from the blower fan through the drain chamber 7 to the drain box 72.

The air (the air containing water such as rainwater) inside the drain chamber 7 is divided into water and air by the water splattering prevention plates 7i, 7i provided in the upper and lower sides of the discharge port 7h, and only the air is discharged from the discharge port 7h to the inside of the vehicle (the inside of the automobile 10) and finally goes out to the outside of the vehicle (the outside of the automobile 10) and is discharged from the discharge port 73 (the hole portion 103) after passing from the blower fan through the drain box 72. Then, the water is discharged to the outside of the vehicle (the outside of the automobile 10) from the discharge port 73 (through the hole portion 103) after passing through the drain chamber 7, blower fan, and the drain box 72, together with the air eliminated by the discharge port 7h. This is the treatment which is performed on the air containing water such as rainwater entering the drain chamber 7 inside the drain chamber 7 in FIGS. 7A and 7B.

The foregoing is the operational state of the wind power generating apparatus 1 in the automobile 10 in which the wind power generating apparatus 1 is mounted. FIGS. 11A and 11B show the automobile 10 in which the wind power generating apparatus 1 shown in FIGS. 6A and 6B, and FIGS. 7A and 7B. However, even in the case where the wind power generating apparatus 1 shown in FIGS. 9A and 9b, and FIGS. 10A and 10B is mounted in the automobile 10, the wind power generating apparatus 1 shown in FIGS. 9A and 9B, and FIGS. 10A and 10B operates similarly. In other words, when the automobile 10 runs, air (air containing water such as rainwater) passes through the air inlet 2 and the air introducing member 6 as similar to the case shown in FIGS. 6A and 6B, and FIGS. 7A and 7B. As similar to FIGS. 6A and 68, and FIGS. 7A and 7B, the air (the air containing water such as rainwater) reaches the drain chamber 7, and is discharged to the outside of the vehicle (the outside of the automobile 10) from the discharge port 73 (through the hole portion 102) after passing from the blower fan storage case 71 through the drain chamber 7 to the drain box 72. Also, the discharge port 7h is formed, and even when the water splattering prevention plates 7i, 7i are attached, as similar to the case shown in FIGS. 7A and 78, the air (the air containing water such as rainwater) is divided into air and water by the water splattering prevention plates 7i, 7i, and only the air is discharged from the discharge port 7. As similar to the case in FIGS. 7A and 7B. The water is discharged to the outside of the vehicle (the outside of the automobile 10) from the discharge port 73 (through the hole portion 103) after passing from the blower fan storage case 72 through the drain chamber 7 to the drain box 72 together with the air.

The embodiment of mounting the wind power generating apparatus 1 on the automobile 10 is not limited to the embodiment shown in FIGS. 11A and 11B, and other embodiments are also possible. Hereinafter, some representative examples are shown. Even when following embodiments different from that in FIGS. 11A and 11B are used, the operational state of the wind power generating apparatus 1 is same as that shown in the example of FIGS. 11A and 11B.

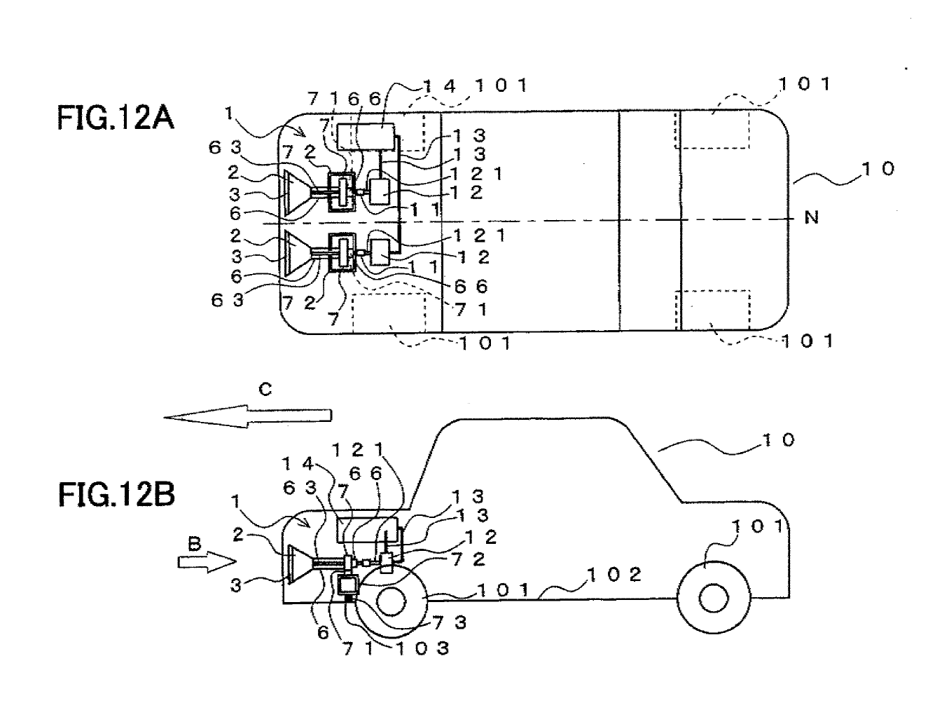

In FIGS. 12A and 12B, the wind power generating apparatus 1 has a two-electric-system configuration in which the battery 14 is commonly used. In other words, portions from the air inlet 2 to the power generator 12 are mounted in the automobile 10 and the electric power cables 13, 13 extending from the two power generators 12 are connected with one battery 14. In FIGS. 12A and 12B, as similar to FIGS. 11A and 11B, the wind power generating apparatus 1 is also mounted on the front side of the automobile 10, and the configuration is made such that when the automobile 10 runs in the direction shown by the arrow C, air (air containing water such as rainwater) can be taken to the end portion 21 side of the air inlet 2 (see, FIG. 1) along the direction shown by the arrow B. Specifically, as similar to FIGS. 11A and 11B, the portions disposed from the air inlet 2 to the power generator 12 are disposed symmetrically across the center axis N of the automobile 10 along the direction of the center axis N of the automobile 10 (see, FIG. 12A). As similar to FIGS. 11A and 11B, the blower fan storage case 71 is attached to each one end portion 7d side of the drain chamber 7 and the drain box 72 and the discharge port 73 are continuously attached from the blower fan storage case 71. As similar to FIGS. 11A and 11B, the discharge port 73 is in communication with the hole portion 103 formed in the floor surface 102 of the vehicle (the automobile 10).

As shown in FIG. 12B, the discharge port 73 is disposed so as to face the outside of the vehicle from the floor surface 102 on the wheel 101 side of the vehicle (the automobile 10), and thus air containing water such as rainwater and water such as rainwater can be discharged to the outside of the vehicle through the hole portion 103. Furthermore, as shown in FIG. 12A, as similar to FIGS. 11A and 11B, each power generator 12 is connected with the battery 14 through the electric power cables 13, each extending in the vehicle width direction of the automobile 10.

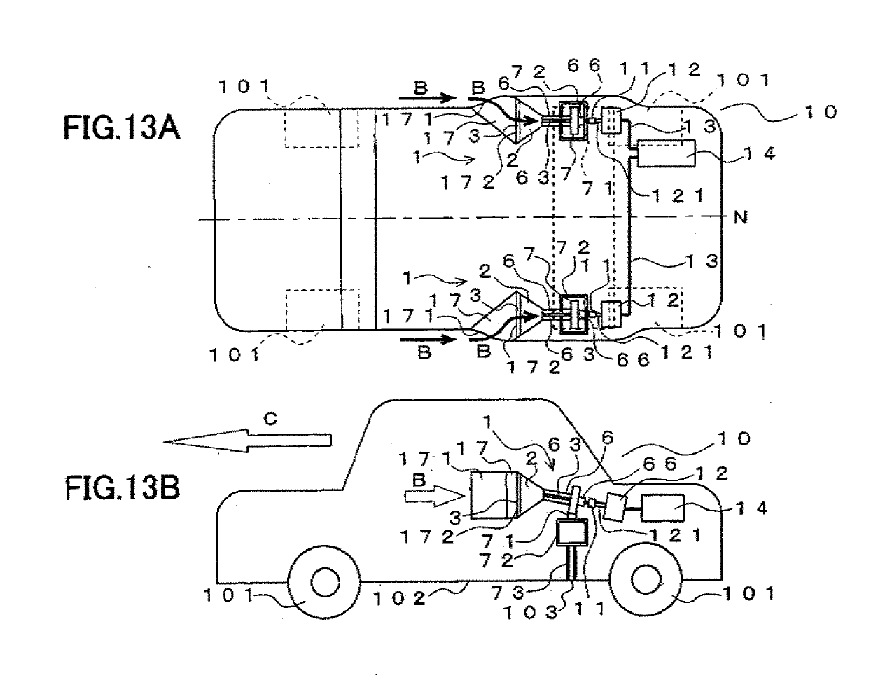

Next, as similar to FIGS. 12A and 12B, as shown in FIGS. 13A and 13B a two-electric-system configuration is provided, in which the battery 14 is commonly used. In other words, portions from the air inlet 2 to the power generator 12 are mounted in the automobile 10 and the electric power cables 13, 13 extending from the two power generators 12 are connected with one battery 14, In FIGS. 13A and 138, different from FIGS. 11A and 11B, and FIGS. 12A and 12B, the wind power generating apparatus 1 is mounted on the rear side of the automobile 10. In addition, air intake ducts 17, 17 are respectively provided and the air inlets 2, 2 are attached to the air intake ducts which are to be mounted in the automobile 10. As shown in FIG. 13A, air intakes are formed by attaching the one end portions 171, 171 of the air intake ducts 17, 17 on the both sides of the automobile 10, and the other end portions 172, 172 of the air intake ducts 17, 17 are attached to the air inlets 2, 2, of the wind power generating apparatuses 1, 1, mounted in the automobile 10. When the automobile 10 runs in the direction shown by the arrow C, air (air containing water such as rainwater) is taken into the one end portions (air intakes) 171, 171 of the air intake ducts 17, 17, which are provided on the both sides of the automobile 10 (in the transverse direction) from the direction shown by the arrow B.

Also, as shown in FIG. 13A, the power generator 12 is disposed along the side surface (the bulged portion) of the automobile 10 from the air inlet 2 disposed parallel to the direction of the center axis N of the automobile 10. In FIGS. 13A and 13B, different from FIGS. 11A and 11B, and FIGS. 12A and 12B, the portions from the air introducing member 6 to the power generator 12 are formed in an inclined manner to become lower toward the rear side (see, FIG. 13B). This is to avoid interference with on-board components of the automobile 10 other than the wind power generating apparatus 1. However, by providing the air intake duct in a lower position, the portions from the air introducing member 6 to the power generator 12 can be disposed without being inclined.

In addition, the portions from the air inlet 2 to the shaft portion 121 or to the power generator 12, which are aligned in line in the plan view of FIG. 13A may be inwardly inclined at an acute angle by using the air inlet 2 side as a fulcrum. Also, in FIG. 13B, the air inlet 2 is disposed in a substantial center of the automobile 10, but it is not necessarily disposed in the substantial center. For example, it is possible that the air inlet 2 is disposed near the floor surface 102 and the portions from the air inlet 2 to the shaft portion 121 and the power generator 12, which are aligned in line, is inclined with respect to the floor surface 102 by using the air inlet 2 disposed near the floor surface 102 as a fulcrum. In this case, the portions from the air inlet 2 to the shaft portion 121 and the power generator 12 make an acute angle with the floor surface 102.

In FIGS. 13A and 13B, as similar to FIGS. 11A and 11B, and FIGS. 12A and 12B, the blower fan storage case 71 is attached on the one end portion 7d side of each drain chamber 7 and the drain box 72 and the discharge port 73 are continuously attached from the blower fan storage case 71. As similar to FIGS. 11A and 11B, and FIGS. 12A and 12B, the discharge port 73 is in communication with the hole portion 103 formed in the floor surface 102 of the vehicle (the automobile 10). Then, as shown in FIG. 13B, the discharge portion 73 is disposed so as to face the outside of the vehicle from the floor surface 102 on the wheel 101 side of the automobile 10, so that air and water such as rainwater of air (air containing water such as rainwater) can be discharged to the outside of the vehicle through the hole portion 103. Furthermore, as shown in FIG. 13A, as similar to FIGS. 11A and 11B, and FIGS. 12A and 12B, each power generator 12 is connected with the battery 14 through the electric power cables 13, each extending to the rear one wheel 101 side in the direction intersecting with the direction of the center axis N of the automobile 10.

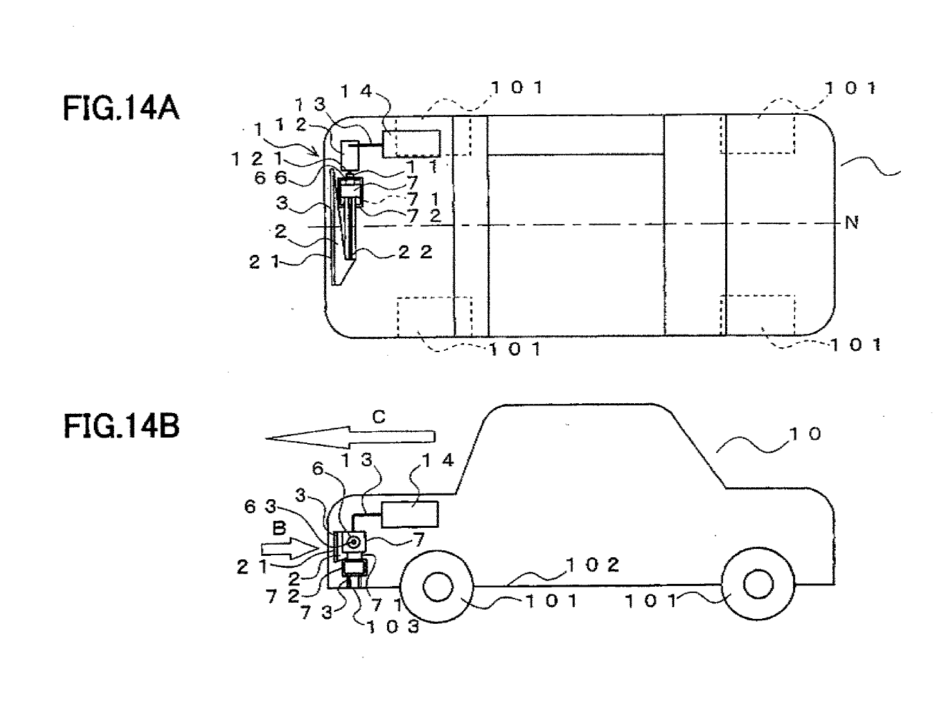

Furthermore, in FIGS. 14A and 14B, as similar to FIGS. 11A and 11B, the wind power generating apparatus 1 is mounted on the front side of the automobile 10. The air inlet 2 is positioned in the front center of the automobile 10 and is formed in the direction intersecting with the center axis N of the automobile 10. For this reason, when the automobile 10 runs in the direction shown by the arrow C, air (air containing water such as rainwater) is easily taken from the one end portion 21 side of the air inlet 2. Different from FIGS. 11A and 11B, and FIGS. 13A and 13B, as shown in FIG. 14A, the air introducing member 6 connected with the air inlet 2 is disposed in the direction intersecting with the center axis N of the automobile 10. This is because the other end portion 22 of the air inlet 2 is formed along the direction of the center axis N of the automobile 10 and thus the air introducing member 6 becomes parallel with the one end portion 21 of the air inlet 2 when the air introducing member 6 is connected with the other end portion 22 of the air inlet 2. As a result, as shown in FIG. 14A, the air introducing member 6 is in a state of being folded over the air inlet 2.

This is an example in which to avoid interference with on-board components of the automobile 10 except the wind power generating apparatus 1 in a case where the air introducing member 6 is difficult to be disposed along the center axis N of the automobile 10 in relationship to the on-board components of the automobile 10 except the wind power generating apparatus I, the air introducing member 6 is disposed in the direction intersecting with the center axis N of the automobile 10 and the air introducing member 6 and the air inlet 2 are disposed to be overlapped with each other. The drain chamber 7 is connected with the air introducing member 6 along the center axis of the air introducing member 6. Also, as similar to FIGS. 11A and 11B, and FIGS. 13A and 13B, as shown in FIG. 14B, the blower fan storage case 71 is attached to the one end portion 7d side of the drain chamber 7 and the drain box 72 and the discharge port 73 are continuously attached from the blower fan storage case 71. As similar to FIGS. 11A and 11B, and FIGS. 13A and 13B, the discharge port 73 is in communication with the hole portion 103 formed in the floor surface 102 of the vehicle (the automobile 10).

The discharge port 73 is provided so as to face the outside of the vehicle from the floor surface 102 on the wheel 101 side of the vehicle (the automobile 10) and can discharge the water such as rainwater and air in the air (air containing water such as rainwater) to the outside of the vehicle through the hole portion 103. Furthermore, the power generator rotational shaft portion 121 connected with the shaft portion 63 through the joint 11 is attached along the direction of the center axis of the air introducing member 6 from the supporting portion 66 continuous to the drain chamber 7. As shown in FIG. 14B, the electric power cable 13 extends from the power generator 12 along the center axis N of the automobile 10 to the wheel 101 side and is connected with the battery 14.

In the foregoing description, provided is the configuration in which the air (the air containing water such as rainwater) and water, which have passed through the air introducing member 6, reach the hollow portion 7a formed inside the drain chamber 7 and the air (the air containing water such as rainwater) and water pass from the blower fan storage case 71 through the drain chamber 7 to the drain box 72 and is quickly discharged from the discharge port 73 (from the hole portion 103) to the outside of the vehicle (the outside of the automobile 10). However, the configuration is not limited. In other words, it is also possible that the blower fan storage case 71 is attached to the one end portion 7d side of the drain chamber 7 and the one end side 721 of the drain box 72 (see, FIG. 1) is attached to the blower fan storage case 71 and the other end portion 722 of the drain box 72 (see, FIG. 1) is directly attached to the floor surface 102 of the vehicle (the automobile 10).

In other words, in the drain box 72 shown in FIG. 1, the length of the drain box 72 in the (center) axis direction is elongated by a length corresponding to the discharge port 73 or the outer diameter of the discharge port 73 is caused to be equal to the outer diameter of the drain box 72 so that the drain box 72 has a function of the discharge port 73 which is a function to discharge the water such as rainwater and the air to the outside of the vehicle. Accordingly, the drain box 72 is in communication with the hole portion 103 formed in the floor surface 102 of the vehicle (the automobile 10). Then, since the drain box 72 functions as the discharge port 73, components of the wind power generating apparatus 1 can be reduced and the assembling process of the wind power generating apparatus I can be simplified. Specifically, given is the configuration in which only the blower fan storage case 71 and the drain box 72 are provided between the drain chamber 7 and the floor surface 102 of the vehicle (the automobile 10). In this manner, the blower fan storage case 71 and the drain box 72 are attached in this order to the one end portion 7d side of the drain chamber 7 and the other side 722 of the drain box 72 is attached to the floor surface 102 of the vehicle (the automobile 10) so as to be connected with the outside of the vehicle (the automobile 10) through the hole portion 73 formed in the floor surface 102 of the vehicle (the automobile 10) from the drain chamber 7 as similar to the case where the discharge port 73 is used.

When the drain box 72 is attached to the floor surface 102 of the vehicle (the automobile 10), although it is not illustrated, a flange portion (an edge portion) extending in the direction perpendicular to the direction of the center axis of the drain box 72 is formed in an end portion of the drain box 72 on the floor surface 102 side of the vehicle (the automobile 10), and a bolt is set in from the flange portion (the edge portion) coming in touch with the floor surface 102 of the vehicle (the automobile 10), so that the drain box 72 and the floor surface 102 of the vehicle (the automobile 10) are connected with each other. However, the drain box 72 and the floor surface 102 of the vehicle (the automobile 10) is not limitedly connected by forming the flange portion and setting the bolt therein but also may be connected by welding means or the like.

As described above, the drain box 72 is connected with the floor surface 102 of the vehicle (the automobile 10), so that the hole portion 103 passing through the floor surface 102 is formed in the floor surface 102 of the vehicle (the automobile 10) to which the drain box 72 is attached. With the attachment of the drain box 72, the drain box 72 surrounds the hole portion 103 and the drain box 72 is in communication with the outside of the vehicle (the automobile 10). However, as similar to the case where the discharge port 73 is attached, the drain box 73 does not necessarily surround the hole portion 103 but the drain box 72 may be set in the hole portion 103. As described above, even when the drain box 72 is directly attached to the floor surface 102 of the vehicle (the automobile 10), as similar to the cases in FIGS. 6A and 6B to FIGS. 14A and 14B, the air (the air containing water such as rainwater) and water which have passed through the air introducing member 6 reach the hollow portion 7a formed inside the drain chamber 7 and are quickly discharged to the outside of the vehicle (the automobile 10) after passing from the blower fan storage case 71 through the drain chamber 7 to the drain box 72. Note that, the drain box 72 has a quadrangular prism shape in this embodiment, but as long as the drain box 72 is in communication with the hole portion 103 formed in the floor surface 102 of the vehicle (the automobile 10), the shape is not particularly limited to the quadrangular prism shape but may be a cylinder.

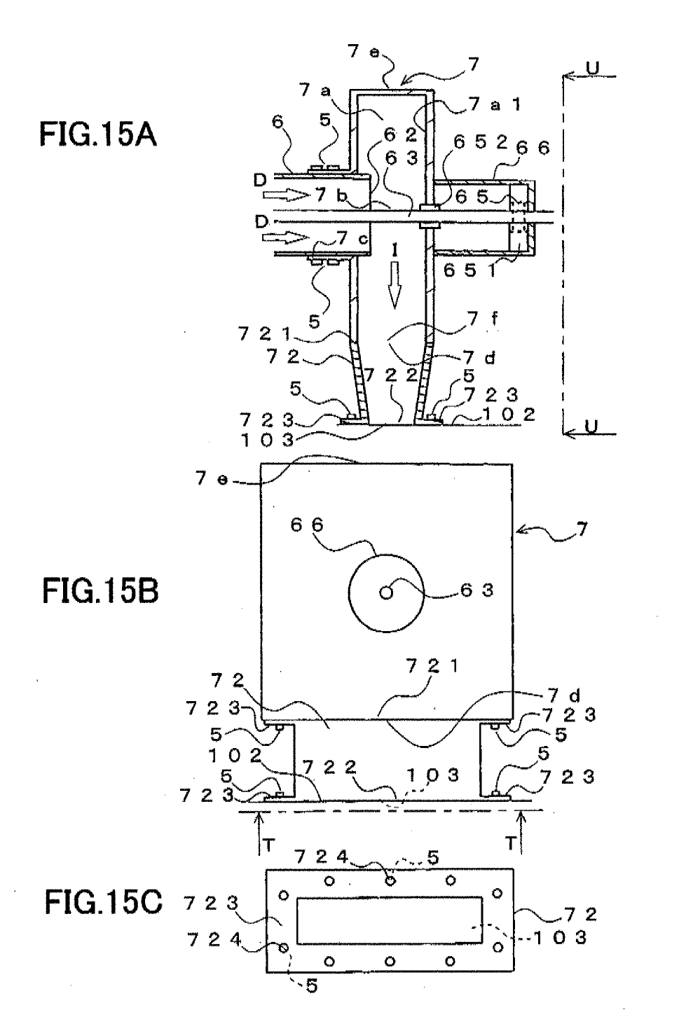

Also, in the wind power generating apparatus 1 mounted in the automobile 10, the blower fan storage case 71 is not necessarily used and the drain box 72 may be also directly attached to the drain chamber 7. As shown in FIGS. 15A to 15C, there is no blower fan storage case 71 on the one end portion 7d side of the drain chamber 7 but the drain box 72 is directly attached. The drain box 72 shown in FIGS. 15A to 15C is basically same as the drain box 72 shown in FIGS. 6A and 6B to FIGS. 14A and 14B, which is provided for discharging the water (content) and air, both having flew through the drain chamber 7. As shown in FIG. 15A, the drain box 72 is in communication with the drain chamber 7. When the drain box 72 shown in FIGS. 15A to 15C is attached to the drain chamber 7, an opening portion 7f formed on the one end portion 7d side of the drain chamber 7 and the one side 721 of the drain box 72 are faced each other and the one side 721 of the drain box 72 is brought in touch with the one end portion 7d side of the drain chamber 7 (see, FIGS. 15A to 15C). In this embodiment, as shown in FIG. 15B, the drain chamber 7 and the drain box 72 are attached (fixed) to each other in such a manner that multiple fixing members 5 being bolts are set in the edge portion 723 of the drain box 72 coming in touch with the other end portion 7d of the drain chamber 7 to be fixed on the one end portion 7d side of the drain chamber 7.

Also, the configuration on the other side 722 of the drain box 72 is basically same with the configuration as described above in which the drain box 72 is in communication with the hole portion 103 of the floor surface 102 of the vehicle (the automobile 10) passing from the drain chamber 7 to the blower fan storage case 71. More specifically, given is the following configuration. A portion of the drain box 72, which comes in touch with the floor surface 102 of the vehicle (the automobile 10) is formed as an edge portion 723 extending along the floor surface 102 as shown in FIG. 15B. Then, when the edge portion 723 comes in touch with the floor surface 102 of the vehicle (the automobile 10), the hole portion 103 of the floor surface 102 is surrounded. As a result, the hole portion 102, which is in communication with the outside of the vehicle (the outside of the automobile 10) and is formed in the floor surface 102, and the drain chamber 7 are in communication with each other through the drain box 72 (see, FIG. 15A). As shown in FIG. 15C, multiple small hole portions 724 passing through the edge portion 723 are formed in the edge portion 723 coming in touch with the floor surface 102, and the drain box 72 is fixed to the floor surface 102 by setting the fixing members being the bolts in the small hole portions 724 (see, FIG. 15B). As shown in FIG. 15C, the edge portion 723 has a rectangular shape, but is not particularly limited to the rectangular shape. As long as the edge portion 723 comes in touch with the floor surface 102 of the vehicle (the automobile 10) and the edge portion 723 is attached to the floor surface 102, the shape may be any form.

As described above, the drain box 72 is attached to the one end portion 7d side of the drain chamber 7. However, as similar to the case of the configuration as described above in which the drain box 72 is in communication with the hole portion 103 of the floor surface 102 of the vehicle (the automobile 10) passing from the drain chamber 7 to the blower fan storage case 71, the configuration is not limited to such that the other side 722 of the drain box 72 surrounds the hole portion 103 but the configuration may be such that the drain box 72 is set in the hole portion 103.

In the foregoing description, the operational state of the automobile 10 in which the wind power generating apparatus 1 with the configuration in FIGS. 15A to 15C is mounted is basically same as the case in which the mechanism shown in FIGS. 6A and 6B to FIGS. 11A and 11B is included. Accordingly, the description is mainly given to the operational state different from that in the case with the mechanism shown in FIGS. 6A and 6B to FIGS. 11A and 11B.

As similar to the mechanism shown in FIGS. 6A and 6B to FIGS. 11A and 11B, when the automobile 10 runs, air (air containing water such as rainwater) is taken into the air inlet 2, and the air (the air containing water such as rainwater) passes through the air introducing member 6 and then reaches the drain chamber 7 along the direction shown by the arrow D in FIG. 15A. The air (the air containing water such as rainwater) having reached the drain chamber 7 passes through the drain chamber 7 (the hollow portion 7a) and passes through the drain box 72 along the direction shown by the arrow I in FIG. 15A. Specifically, the air (the air containing water such as rainwater) which flows from the other end portion 62 of the air introducing member 6 along the direction shown by the arrow D and comes in touch with the seal member 652 side which is along the axial direction of the drain chamber 7 and is opposite to the air introducing member 6, is divided into the one end portion 7d side and other end portion 7e side of the drain chamber 7. The air (the air containing water such as rainwater) having gone to the one end portion 7 side of the drain chamber 7 goes to the drain box 72 along the direction shown by the arrow I in FIG. 15A and is discharged to the outside of the vehicle (the outside of the automobile 10) through the drain box 72. Also, the air (the air containing water such as rainwater) having gone to the other end portion 7e side of the drain chamber 7 returns at the other end portion 7e side of the drain chamber 7e and goes to the drain box 72 along the direction shown by the arrow I in FIG. 15A, and then is discharged to the outside of the vehicle (the outside of the automobile 10) through the drain box 72.

Also, the air (the air containing water such as rainwater) passing through the inner periphery side of the air introducing member 6 in the air (the air containing water such as rainwater) passing through the air introducing member 6 goes to the one end portion 7d side and other end portion 7e side of the drain chamber 7 when going out the air introducing member 6. The air (the air containing water such as rainwater) having gone to the one end portion 7d side of the drain chamber 7 goes to the drain box 72 along the direction shown by the arrow I in FIG. 15A and is discharged to the outside of the vehicle (the outside of the automobile 10) from the drain box 72. Similarly, the air (the air containing water such as rainwater) having gone to the other end portion 7e of the drain chamber 7 goes to the other end portion 7e side of the drain chamber 7 but returns at the other end portion 7e side of the drain chamber 7 and finally discharged to the outside of the vehicle (the automobile 10) from the drain box 72 along the direction shown by the arrow I in FIG. 15A. Similarly, the water such as rainwater in the air (the air containing water such as rainwater) having reached the inside of the drain chamber 7 passes through the drain chamber 7 (the hollow portion 7a) and passes through the drain box 72 along the direction shown by the arrow I in FIG. 15A.

In other words, the water such as rainwater in the air (the air containing water such as rainwater) having reached the inside of the drain chamber 7 is sprayed onto the wall surface 7a1 side of the hollow portion 7a when passing through the air introducing member 6. For this reason, the water adhered to the wall surface 7a1 side of the hollow portion 7a moves on the wall surface 7a1 of the hollow portion 7a along the direction shown by the arrow I in FIG. 15A toward the drain box 72 side, and is discharged to the outside of the vehicle (the automobile 10) from the drain box 72. Also, the water such as rainwater having not adhered onto the wall surface 7a1 of the hollow portion 7a passes through the drain box 72 along the direction shown by the arrow I in FIG. 15A and then is discharged to the outside of the vehicle (the automobile 10) from the drain box 72. As described above, the air (the air containing water such as rainwater) passing through the air inlet 2 and the air introducing member 6 in the case where the automobile 10 runs is finally discharged to the outside of the vehicle (the automobile 10) through the drain chamber 7 and the drain box 72.

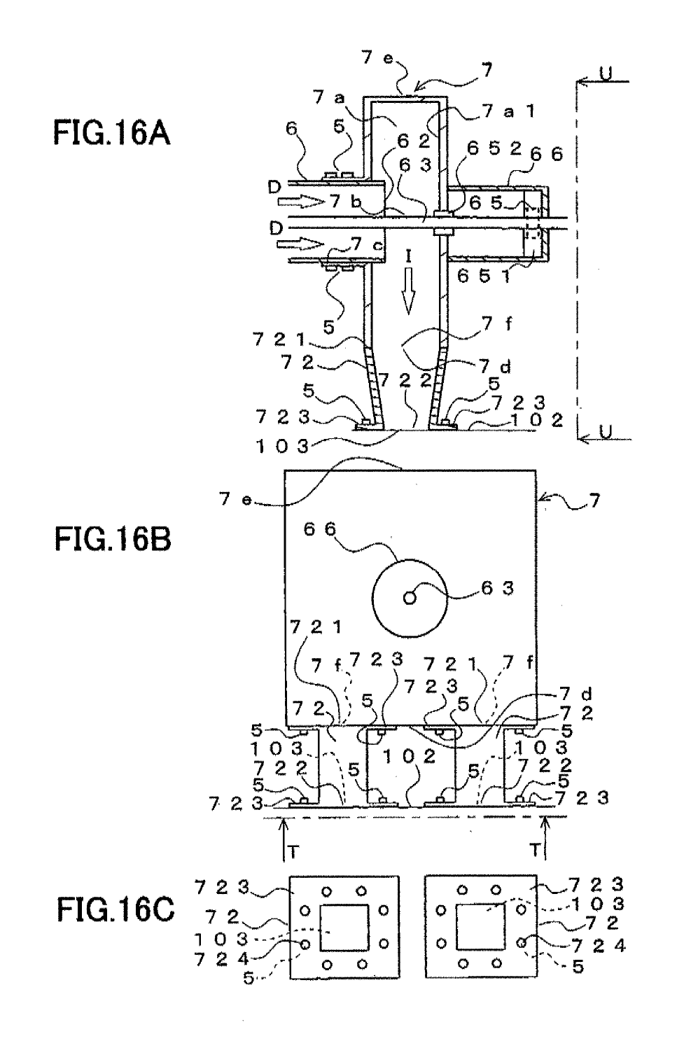

The foregoing description is about the configuration in which the drain chamber 7 is used and the drain box 72 is attached and about the operational state of the wind power generating apparatus I with the configuration. However, the structure of the drain chamber 7 is not limited to the structure shown in FIG. 15. For example, the wind power generating apparatus 1 can be configured by attaching the drain box 72 in the drain chamber 7 shown in FIGS. 9A and 9B, and FIGS. 10A and 10B. In other words, the configuration in which the drain box 72 is directly attached to the drain chamber 7 and the air (the air containing water such as rainwater) is discharged to the outside of the vehicle (the automobile 10) from the drain box 72 is not particularly limited to the configuration shown in FIGS. 15A to 15C, and the configuration shown in FIGS. 16A to 16C may be used.

FIGS. 16A to 16C show the configuration in which multiple drain boxes 72 are attached in parallel to the drain chamber 7. Although FIGS. 16A to 16C show an example in which the two drain boxes 72 are used, the number of the drain boxes 72 is not particularly limited to two. As shown in FIG. 16B, in the wind power generating apparatus 1, the one side 721 of the drain box 72 is brought in touch with each of the opening portions 7f, 7f which are formed side by side on the one end portion 7d side of the drain box 7, so that the drain box 72 is attached (see, FIG. 16A). When the attachment is made, as similar to the case shown in FIGS. 15A to 15C, the fixing member 5 being the bolt is set in the end portion 723 of the drain box 72 coming in touch with the drain chamber 7 as shown in FIG. 16B, so that the drain chamber 7 and the two drain boxes 72 are connected with each other.

Also, on the other side 722 of the two drain boxes 72, as similar to the case shown in FIG. 16A, the edge portion 723 of the drain box 72, which is a portion coming in touch with the floor surface 102 and is formed so as to extend in the direction perpendicular to the direction of the center axis of the drain box 72, comes in touch with the floor surface 102 of the vehicle (the automobile 10) as shown in FIG. 16A and surround the hole portion 103 of the floor surface 102. Then, the fixing member 5 being the bolt is set in each of multiple small through-hole portions 724 formed in the edge portion 723 (see, FIG. 16C), so that the two drain boxes 72 are fixed in the floor surface 102. As a result, the hole portion 103 being in communication with the outside of the vehicle (the automobile 10), which is formed in the floor surface 102 and the drain chamber 7 are in communication with each other through the drain box 72 (see, FIG. 16A). Also, as similar to the case in FIG. 15, the configuration is not limited to the case where the other side 722 of the drain box 72 surrounds the hole portion 103, and the configuration in which the drain box 72 is set in the hole portion 103 is also possible.

The operational state of the wind power generating apparatus 1 inside the automobile 10 in which the wind power generating apparatus 1 having the configuration in FIGS. 16A to 16C is installed is same as the case with the mechanism shown in FIGS. 15A to 15C. In other words, as similar to the case in FIGS. 15A to 15C, the air (the air containing water such as rainwater) and water which have reached the inside of the drain chamber 7 after having passed through the air introducing member 6 along the direction shown by the arrow D as shown in FIG. 16A pass through the drain box 72 along the direction shown by the arrow I in the drain chamber 7 (the hollow portion 7a). In FIGS. 16A to 16C, there are two drain boxes 72. Thus, the air and the water pass through each drain box 72 long the direction shown by the arrow I. After that, the air (the air containing water such as rainwater) and the water such as rainwater are finally discharged from the hole portion 103 in the floor surface 102 of the vehicle (the automobile 10) to the outside of the vehicle (the automobile 10).

In the above description, in the wind power generating apparatus 1, the drain box 72 is attached by using the drain chamber 7 shown in FIGS. 16A to 16C. However, as similar to the case in FIG. 15, the drain chamber 7 is not limited to the drain chamber 7 shown in FIGS. 16A to 16C. For example, multiple drain boxes 72 may be attached (connected) by using the drain chamber shown in FIGS. 6A and 6B, 9A and 9B or 10A and 10B to form the wind power generating apparatus 1. Even in this case, the configuration is such that the drain chamber 7 and the multiple drain boxes 72 are connected with each other, and as shown in FIGS. 16A to 16C, the operational state of the wind power generating apparatus 1 becomes same as the operational state of the wind power generating apparatus 1 in which the drain chamber 7 and the multiple drain boxes 72 are connected with each other. Note that the shape of the drain box 72 is not particularly limited to the quadrangular prism, and may be formed as a cylinder.

Note that consumable items such as the bearing 65 and parts requiring maintenance are detachably attached in the wind power generating apparatus 1.

The wind power generating apparatus 1 is basically supported by the frame portion 15 and the system supporting stand 16 as shown in FIGS. 16A to 16C. However, depending on the size of the drain box 72 including the discharge port 73 which is attached in the floor surface of the vehicle (the automobile 10), more specifically, if the drain box 72 including the discharge port 73 coming in touch with the floor surface 102 of the vehicle (the automobile 10) is large, the drain box 72 may support the wind power generating apparatus 1.

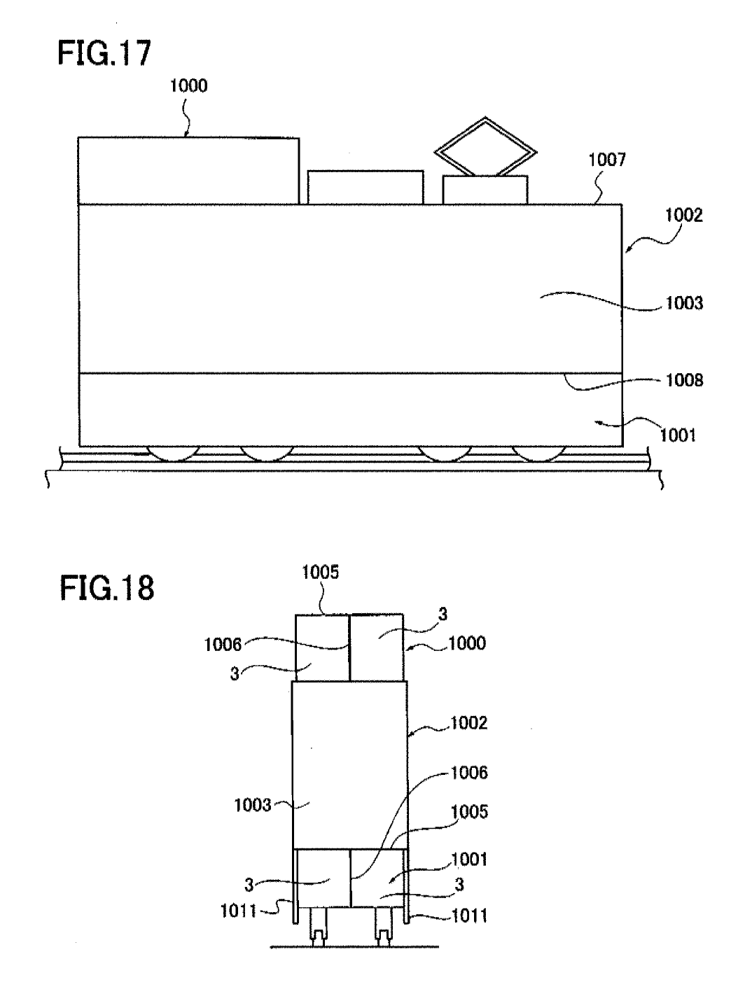

FIG. 17 to FIGS. 21A to 21C show a second embodiment of a movable object-mounted wind power generating apparatus according to the present invention. The second embodiment shows a case where the movable object-mounted wind power generating apparatus according to the present invention is applied to a train.

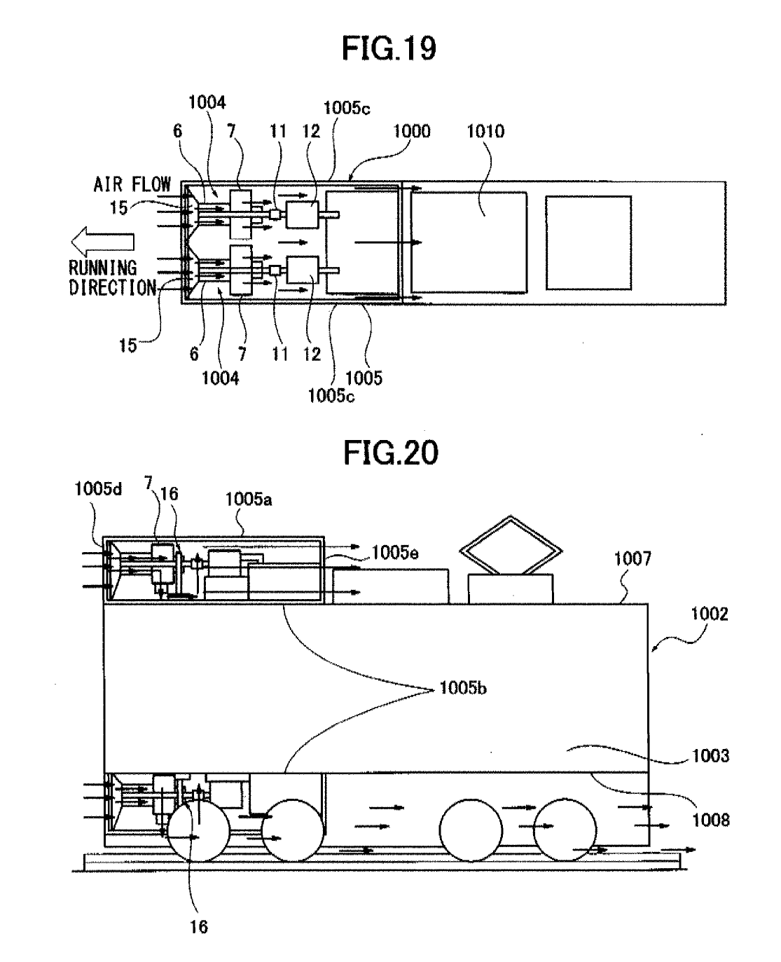

In the second embodiment, as shown in FIG. 17 and FIG. 18, first and second units 1001 and 1001 in each of which multiple wind power generating apparatuses are combined are respectively provided on the roof and lower portion of a vehicle body 1003 of a train 1002. Each of the first and second units 1000, 1001 has two combined wind power generating apparatuses as shown in FIG. 19 and FIG. 20, and each wind power generating apparatus 1004 has the configuration substantially same as that of the wind power generating apparatus I as described in the first embodiment. Accordingly, same reference numerals are given to denote portions of the wind power generating apparatus 1004 same as those of the wind power generating apparatus 1, and the description thereof is omitted. Note that as long as at least one wind power generating apparatus is mounted in any position of the vehicle body 1003, the number of the wind power generating apparatuses is not limited. When the number of the wind power generating apparatuses increase, the amount of power generation also naturally increases.

In each of the first unit 1000 and the second unit 1001, two wind power generating apparatuses are disposed side by side inside a protection case 1005. If necessary, the two wind power generating apparatuses may be separated by a partition wall 1006 (see, FIG. 18). The protection case 1005 has an upper wall 1005a and a lower wall 1005b so as to shield the two wind power generating apparatuses (see, FIG. 19 and FIG. 20). A front wall 1005a is opened so as to take air from an air inlet of the wind power generating apparatus and a rear wall 1005e is opened to discharge the air having entered in the protection case 1005.

As similar to the first embodiment, each wind power generating apparatus 1004 is fixed in any position of a vehicle body of a train by a fixing mechanism. More specifically speaking, a portion of the air inlet 2 is fixed by a frame portion 15 to the front surface of the protection case 1005 and a supporting portion 66 in the rear portion of the drain chamber 7, which is disposed on a side opposite to the air inlet 2, is fixed by a supporting mechanism 16 to the protection case 1005.

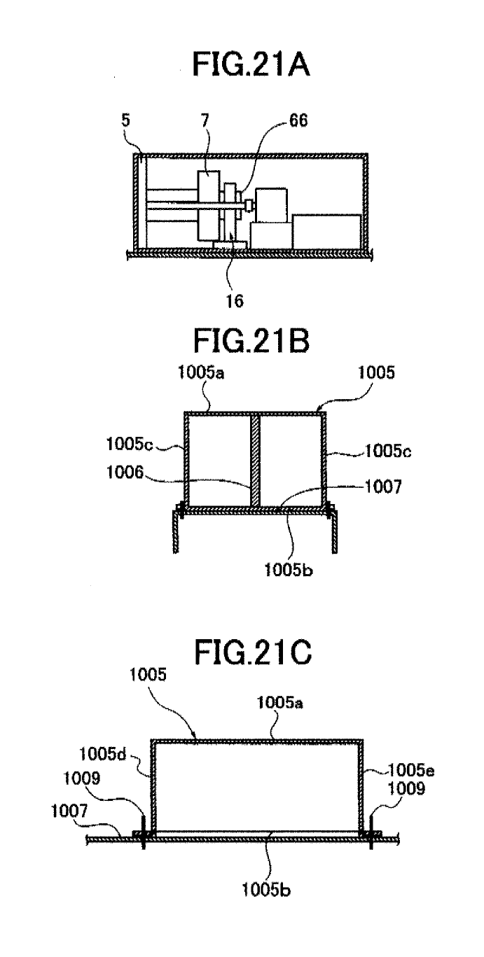

This protection case 1005 is firmly fixed by any fixing device, for example, a bolt fastener 1009 to an outer surface 1007 of a roof of the vehicle body 1003 of the train and to an outer surface 1008 of the floor surface of the vehicle body (see, FIG. 21B and FIG. 21C). Here, note that the protection case 1005 has to be attached to a position which is not disturbed by an outdoor equipment of an air conditioner, a wheel, a motor, and the like which are originally provided with the train 1002.

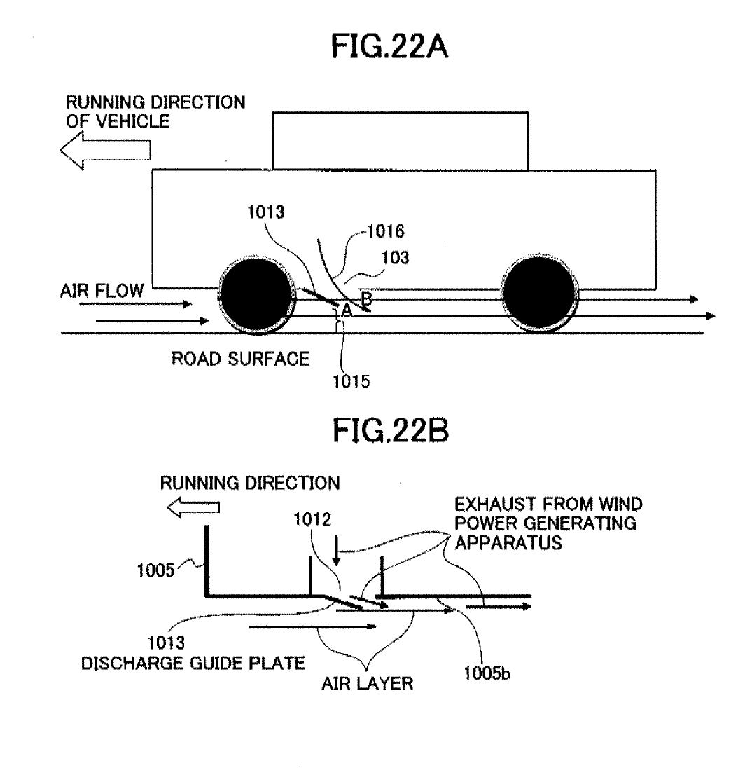

In FIG. 22A and FIG. 22B, in the first and second embodiments, provided is a discharge mechanism for smoothly discharging air and the like inside the drain chamber 7 to the outside thereof.

In general, when a vehicle is running, a large amount of air flows between a bottom of the vehicle and a road surface at a speed in proportion with the vehicle speed. For this reason, when the air and the like inside the drain chamber are discharged to the outside of the vehicle, a pressure is caused along with the flow of the air between the bottom of vehicle and the road surface, which prevents the smooth discharge. To solve this phenomenon, as shown in FIG. 22A, a discharge guide plate 1013 is provided at an exit of the hole portion 103 provided in the floor surface of the vehicle, so that air can be smoothly discharged from the drain chamber (see FIG. 22A). In the discharge guide plate 1013, the front end in the running direction of the vehicle is attached to the front edge of the hole portion, and the rear end extends in the direction opposite to the running direction of the vehicle. More specifically, the discharge guide plate 1013 extends obliquely downward from the front end to the rear end.

By providing the discharge guide plate 1013, the pressure near the exit of the discharge guide plate 1013 is decreased more than the pressure of an air layer flowing between the vehicle and the road surface. Accordingly, when the air is discharged from the drain chamber along the discharge guide as shown in the arrow 1016, the air is smoothly discharged. Furthermore, the air and water which have once been discharged join the air layer flowing between the vehicle and the road surface after having left from the discharge guide exit, which results in increasing the flow speed. More specifically speaking, the pressure in A area is higher than the pressure in B area, and the air flow hardly exists near the discharge guide plate exit in the B area. Accordingly, the air in the A area whose one portion has a high pressure enters the B area with the low pressure in a turbulent state. Thus, the air in the drain chamber is smoothly discharged as shown by the arrow 1016.

FIG. 22B shows a state where the discharge guide plate 1013 is provided in the discharge port 1012 provided in the lower wall 1005b of the protection case 1005 in the second embodiment. In order that the air and the like smoothly flow to the outside as shown by the arrow in FIG. 22B, this discharge guide plate 1013 is provided such that the front end in the running direction of the train is attached to the front edge and the rear end extended obliquely downward in the outside of the protection case (see FIG. 22B). The principle and function of the discharge guide plate 1013 are same as those described above.

The rainwater and the like which have been discharged from the protection case 1005 flows, for example, along an existing watershoot or the like (not shown) which is provided in the train. Note that the discharge guide plate 1013 of the drain chamber 7 is mainly provided in an opening of the drain chamber in the first embodiment.

In the case of the first unit 1000 provided on the roof of the vehicle body 1003, the water and the like discharged from the drain chamber 7 is flown to the outside of the vehicle body through a regular watershoot provided on the roof of the train.

In the case of the second unit 1001 provided in the lower portion of the vehicle body 1003, anti-water scattering plates 1011, 1011 are provided on the both sides of the vehicle body of the train 1002 so as to hold the second unit 1001 therebetween (see, FIG. 18). These anti-water scattering plates 1011, 1011 are for preventing the water discharged from the drain chamber of the wind power generating apparatus from being scattered around the vehicle body.

As described above, the wind power generating apparatus is mounted in the train and air which is received by the train when the train is running is taken to the air introducing member 6 through the air inlet 2. The taken air drives the power generator 12 disposed in the air introducing member 6 and the driven power generator 12 generates power. The air and water which have taken in the air introducing member 6 are discharged to the outside of the vehicle body after being buffered and gathered in the drain chamber 7 as described in the first embodiment.

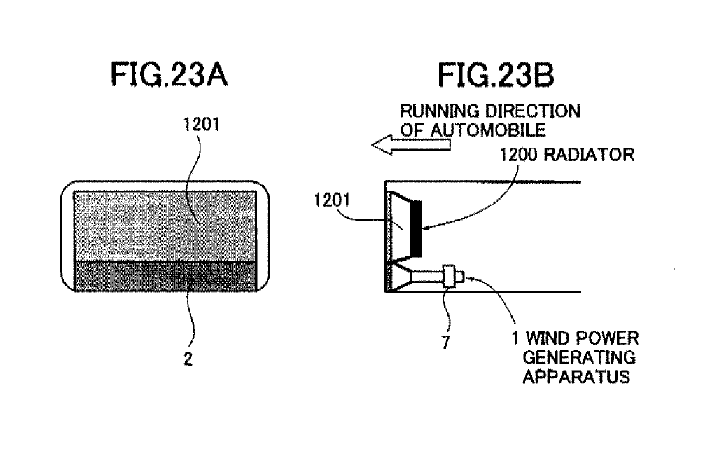

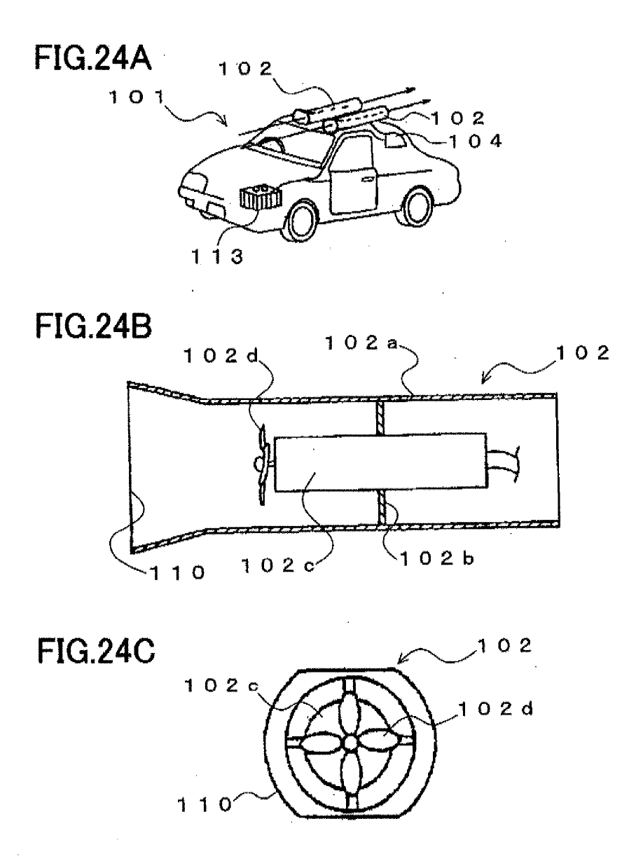

FIGS. 23A and 23B show a modification of the movable object-mounted wind power generating apparatus according to the present invention. In the modification, the movable object-mounted wind power generating apparatus 1 has a configuration which can handle the problem such that when the wind power generating apparatus 1 is applied to a gasoline engine vehicle or HEV (a hybrid vehicle), a diesel engine vehicle, or the like, in the vehicle, a radiator 1200 has to be cooled, and thus the shape and position of the air inlet 2 of the wind power generating apparatus 1 have to be also changed. More briefly, the air inlet 2 of the movable object-mounted wind power generating apparatus 1 is disposed next to the lower side of the air inlet 1201 for the radiator 1200.

As described above, in the movable object-mounted wind power generating apparatus according to the present invention, the drain chamber in communication with the air outlet of the body has a cross-sectional area or volume larger than the opening area of the air outlet. Accordingly, when the air entered the drain chamber from the air outlet, the air expands and the speed and pressure are decreased. Thus, the air decreases the speed in the drain chamber and loses the stream, and is quickly and smoothly discharged to the outside of the vehicle from the drain chamber. Also, the inner wall of the drain chamber which faces the air outlet is bulged toward the outside. Accordingly, when the air blown out from the air outlet collides with the inner surface of the drain chamber, the flow is further weakened and gathered by the recessed curved surface. Thus, the air whose flow is weakened and which is gathered is smoothly discharged to the outside of the vehicle from the drain chamber. Consequently, the air containing rainwater, dust, and the like can be quickly discharged.

The various preferred embodiments of the movable object-mounted wind power generating apparatus according to the present invention have been described. However, the present invention is not limited to these embodiments. One skilled in the art should understand that various modifications and changes can be made in these embodiments.

What is claimed is:

1. A movable object-mounted wind power generating apparatus which is mounted on a movable object and generates electricity with wind force to be generated while the movable object is running, the movable object-mounted wind power generating apparatus comprising:
an air introducing member being attached to an inside of the movable object and having, at one end thereof, an air inlet which introduces air to be received by the movable object and, at the other end thereof, an air outlet which discharges the air introduced from the air inlet;
a generator driving mechanism which is drivably disposed inside the air introducing member and is connected with a power generator and which is driven by the air introduced inside the air introducing member from the air inlet, thereby driving the power generator; and
a drain mechanism which is connected with the air outlet and buffers the air inside the air introducing member to discharge the air to an outside of the movable object,
the drain mechanism including a drain chamber which is in communication with the air outlet of the air introducing member and into which the air discharged from the air outlet is introduced to expand the introduced air in the drain chamber.

2. The movable object-mounted wind power generating apparatus according to claim 1, the drain chamber has a cross-sectional area larger than an opening area of the air outlet.

3. The movable object-mounted wind power generating apparatus according to claim 1, wherein the drain chamber includes a discharge opening provided to discharge the air inside the drain chamber to the outside of the movable object.

4. The movable object-mounted wind power generating apparatus according to claim 1, wherein an inner wall of the drain chamber which faces the air outlet is bulged toward the outside.

5. The movable object-mounted wind power generating apparatus according to claim 1, further comprising a filter provided in the air inlet.

6. The movable object-mounted wind power generating apparatus according to claim 1, wherein the drain mechanism includes a blower fan provided to suck the air and the like inside the drain chamber.

7. The movable object-mounted wind power generating apparatus according to claim 6, wherein
the drain mechanism includes a pressure sensor configured to detect a pressure inside the drain chamber, and
when the pressure sensor detects that the pressure inside the drain chamber is equal to or larger than a predetermined value, the blower fan is activated.

8. The movable object-mounted wind power generating apparatus according to claim 1, wherein the drain mechanism has at least one discharge port provided in the drain chamber and a water splattering prevention device provided in the discharge port so as to prevent water in the air from passing therethrough.

9. The movable object-mounted wind power generating apparatus according to claim 1, wherein the movable object is an automobile.

10. The movable object-mounted wind power generating apparatus according to claim 1, wherein the movable object is a train.
